(19) United States
(12) Patent Application Publication
(10) Pub. No.: US 2014/0194209 A1
(43) Pub. Date: Jul. 10, 2014

(54) PLATFORMS FOR COMMUNITY GAME DEVELOPMENT AND COMMUNITY MANAGEMENT OF GAME LIFECYCLE

(71) Applicants: Polyxeni Ziouvelou, Athens (GR); Gregory S. Yovanof, Athens (GR); Eleftheria Giannaka, Athens (GR); Ioannis Loukeris, Athens (GR); Fotis Talantzis, Athens (GR); Didoe Prevedourou, Athens (GR); George Zenzefilis, Athens (GR); Andreas Ninios, Athens (GR); Haralambos C. Karathanasis, Athens (GR)

(72) Inventors: Polyxeni Ziouvelou, Athens (GR); Gregory S. Yovanof, Athens (GR); Eleftheria Giannaka, Athens (GR); Ioannis Loukeris, Athens (GR); Fotis Talantzis, Athens (GR); Didoe Prevedourou, Athens (GR); George Zenzefilis, Athens (GR); Andreas Ninios, Athens (GR); Haralambos C. Karathanasis, Athens (GR)

(21) Appl. No.: 14/150,697

(22) Filed: Jan. 8, 2014

Related U.S. Application Data
(60) Provisional application No. 61/750,067, filed on Jan. 8, 2013.

(51) Int. Cl. A63F 13/30

(52) U.S. Cl. CPC A63F 13/12
USPC 463/42

(57) ABSTRACT

In some embodiments, the instant invention provides for a method for community game development and community management of game lifecycle that includes at least the following steps: offering, by a specifically programmed virtual gaming platform, a personalized computer interface to each of at least 1,000 users of an virtual game community managed by the specifically programmed virtual gaming platform; where the at least one first computer interface is configured to allow each of the at least 1,000 users to create a game idea; receiving, a plurality of game ideas; receiving game idea votes on each game idea of the plurality of game ideas; automatically ranking the plurality of game ideas based, at least in part, on the game idea votes; and automatically selecting at least one winning game idea to be developed by the virtual game community based, at least in part, on the ranking the plurality of game ideas.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### RELATED APPLICATIONS

This application claims the priority of U.S. provisional application Ser. No. 61/750,067, entitled “A PLATFORMS FOR COLLABORATIVE GAME DEVELOPMENT AND USES THEREOF,” filed Jan. 8, 2013, which is incorporated herein by reference in its entirety for all purposes.

### TECHNICAL FIELD

In some embodiments, the instant invention is related platforms for community game development and community management of game lifecycle (e.g., launch, maintenance, updates, etc.).

### BACKGROUND OF INVENTION

In some instance, a typically game is developed through input of employees of a particular company or a group of people who came up with a game in the first place.

### BRIEF SUMMARY OF INVENTION

In some embodiments, the instant invention provides for a method for community game development and community management of game lifecycle that includes at least the following steps: offering, by a specifically programmed virtual gaming platform, at least one first personalized computer interface to each of at least 1,000 users of an virtual game community managed by the specifically programmed virtual gaming platform; where the at least one first computer interface is configured to allow each of the at least 1,000 users to create at least one game idea; where the specifically programmed virtual gaming platform is configured to concurrently receive the at least one game idea from each of the at least 1,000 users of the virtual game community; where the specifically programmed virtual gaming platform is configured to automatically output, in real-time, a first plurality of game selections during creation of the at least one game idea based, at least in part, on data collected about the virtual game community; receiving, by the specifically programmed virtual gaming platform, a plurality of game ideas; receiving, by the specifically programmed virtual gaming platform, game idea votes on each game idea of the plurality of game ideas; automatically ranking, by the specifically programmed virtual gaming platform, the plurality of game ideas based, at least in part, on the game idea votes; automatically selecting, by the specifically programmed virtual gaming platform, at least one winning game idea to be developed by the virtual game community based, at least in part, on the ranking the plurality of game ideas; automatically identifying, by the specifically programmed virtual gaming platform, at least one first game developer whose at least one skill is suited for development of the at least one winning game idea based, at least in part, on matching at least one characteristic of the at least one winning game idea to information about skills possessed by game developers; automatically determining, by the specifically programmed virtual gaming platform, a role to be performed by at least one first game developer in developing the at least one winning game; receiving, by the specifically programmed virtual gaming platform, funds for developing of the at least one winning game; automatically outputting, in real-time, by the specifically programmed virtual gaming platform, a second plurality of game, where the second plurality of game selections is outputted during the development of the at least one wining game idea based, at least in part, on the data collected about the virtual game community; after the at least one winning game has been developed, tracking, by the specifically programmed virtual gaming platform, a validation of the at least one winning game; after the at least one winning game has been validated, automatically offering, by the specifically programmed virtual gaming platform, the at least one winning game to be played; receiving, by the specifically programmed virtual gaming platform, game reviews to the at least one winning game; managing, by the specifically programmed virtual gaming platform, at least one revision of the at least one winning game based, at least in part, on the game reviews; and offering, by the specifically programmed virtual gaming platform, at least one marketplace where the users of the virtual gaming community can perform at least one of the following activity: i) buy or sell at least one of the following: 1) a first game idea, 2) a first game, 3) a first game component, and 4) a first game content, ii) participate in an auction to buy or sell at least one of the following: 1) a second game idea, 2) a second game, 3) a second game component, and 4) a second game content, iii) fund development of at least one of: 1) the at least one winning game, 2) a third game, 3) a third game idea, 4) a third game component, and 5) a third game content, and iv) outsource development of at least one of: 1) the at least one winning game, 2) a fourth game, 3) a fourth game idea, 4) a fourth game component, and 5) a fourth game content.

In some embodiments, the users are registered members of the virtual game community.

In some embodiments, at least one first user who has created the at least one wining game idea is not the at least one first game developer.

In some embodiments, the at least one game idea comprises at least one game prototype.

In some embodiments, the at least one first personalized computer interface comprises a WYSIWYG-like editor or program.

In some embodiments, the method further includes: registering, by the specifically programmed virtual gaming platform, the game developers with the virtual game community, and offering, by the specifically programmed virtual gaming platform, at least one skills survey during the registering to compile the information about skills possessed by the game developers.

In some embodiments, the method further includes: setting, by the specifically programmed virtual gaming platform, at least one predetermine time period to receive at least one of the following: i) the game idea votes, ii) the validation of the at least one winning game, and iii) the game reviews.

In some embodiments, the method further includes: setting, by the specifically programmed virtual gaming platform, at least one predetermine threshold quantity of at least one of the following: i) the game idea votes, ii) the validation of the at least one winning game, and iii) the game reviews. In some embodiments, the at least one predetermine threshold quantity is at least one of the following: i) at least 1,000, ii) at least 5,000, and iii) at least 10,000.

In some embodiments, the method further includes: offering, by the specifically programmed virtual gaming platform, the users of the virtual game community to access at least one social media network to generate at least one of the following: i) the game idea votes, ii) the validation of the at least one winning game, and iii) the game reviews.

In some embodiments, the instant invention provides for a specifically programmed virtual gaming system that includes at least the following components: at least one specialized computer machine that includes: a non-transient memory having at least one region for storing particular computer executable program code; and at least one processor for executing the particular program code stored in the memory, where the particular program code is configured so that the at least one specialize computer machine is configured to at least perform the following operations: offering at least one first personalized computer interface to each of at least 1,000 users of an virtual game community managed by the specifically programmed virtual gaming platform; where the at least one first computer interface is configured to allow each of the at least 1,000 users to create at least one game idea; where the specifically programmed virtual gaming system is configured to concurrently receive the at least one game idea from each of the at least 1,000 users of the virtual game community; where the specifically programmed virtual gaming system is configured to automatically output, in real-time, a first plurality of game selections during creation of the at least one game idea based, at least in part, on data collected about the virtual game community; receiving a plurality of game ideas; receiving game idea votes on each game idea of the plurality of game ideas; automatically ranking the plurality of game ideas based, at least in part, on the game idea votes; automatically selecting at least one winning game idea to be developed by the virtual game community based, at least in part, on the ranking the plurality of game ideas; automatically identifying at least one first game developer whose at least one skill is suited for development of the at least one winning game idea based, at least in part, on matching at least one characteristic of the at least one winning game idea to information about skills possessed by game developers; automatically determining a role to be performed by at least one first game developer in developing the at least one winning game; receiving funds for developing of the at least one winning game; automatically outputting, in real-time a second plurality of game, where the second plurality of game selections is outputted during the development of the at least one wining game idea based, at least in part, on the data collected about the virtual game community; after the at least one winning game has been developed, tracking a validation of the at least one winning game; after the at least one winning game has been validated, automatically offering the at least one winning game to be played; receiving game reviews to the at least one winning game; managing at least one revision of the at least one winning game based, at least in part, on the game reviews; and offering at least one marketplace where the users of the virtual gaming community can perform at least one of the following activity: i) buy or sell at least one of the following: 1) a first game idea, 2) a first game, 3) a first game component, and 4) a first game content, ii) participate in an auction to buy or sell at least one of the following: 1) a second game idea, 2) a second game, 3) a second game component, and 4) a second game content, iii) fund development of at least one of: 1) the at least one winning game, 2) a third game, 3) a third game idea, 4) a third game component, and 5) a third game content, and iv) outsource development of at least one of: 1) the at least one winning game, 2) a fourth game, 3) a fourth game idea, 4) a fourth game component, and 5) a fourth game content.

### BRIEF DESCRIPTION OF THE FIGURES

The present invention can be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIG. 1 is an illustrative computer system architecture representative of some embodiments of the present invention.

FIG. 2 is also illustrative computer system architecture representative of some embodiments of the present invention.

FIG. 3 is a flowchart representative of some embodiments of the present invention.

FIGS. 4-17C are screenshots representative of some embodiments of the present invention.

FIGS. 18-35 are flowcharts representative of some embodiments of the present invention.

FIG. 36 is also an illustrative computer system architecture representative of some embodiments of the present invention.

FIG. 37 is also an illustrative computer system architecture representative of some embodiments of the present invention.

In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention can become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

### DETAILED DESCRIPTION OF INVENTION

Among those benefits and improvements that have been disclosed, other objects and advantages of this invention can become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive. Any alterations and further modifications of the inventive feature illustrated herein, and any additional applications of the principles of the invention as illustrated herein, which can normally occur to one skilled in the relevant art and having possession of this disclosure, are to be considered within the scope of the invention.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Illustrative Operating Environments

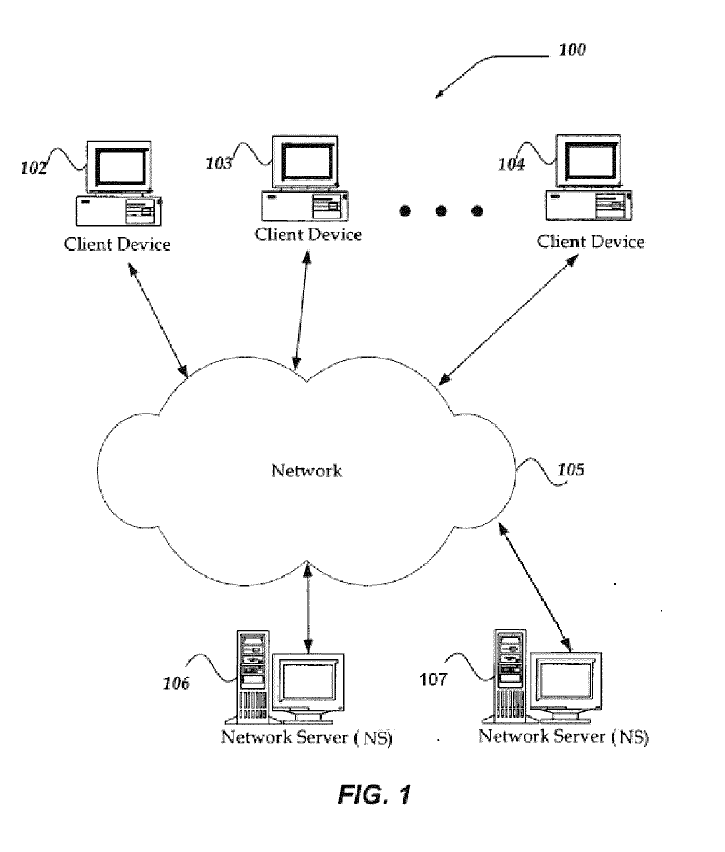

FIG. 1 illustrates one embodiment of an environment in which the present invention may operate. However, not all of these components may be required to practice the invention, and variations in the arrangement and type of the components may be made without departing from the spirit or scope of the invention. In some embodiments, the inventive system and method may include a large number of users/members (e.g., at least 1,000, at least 10,000; at least 100,000; at least 1,000,000) and/or concurrent requests/submissions/actions (e.g., at least 1,000; at least 10,000; at least 100,000; at least 1,000,000). In other embodiments, the inventive system and method are based on a scalable computer and network architecture that incorporates varies strategies for assessing the data, caching, searching, and database connection pooling. An example of the scalable architecture is an architecture that is capable of operating multiple servers.

In embodiments, members of the inventive computer system 102-104 (e.g., computer/mobile devices of game developers, players, investors, etc.), include virtually any computing devices capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a tablet, PDA, POCKET PC, wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In embodiments, the invention is programmed in either PHP, Javascript, Unix Shell, Java, .Net, QT, C, C++ or other suitable programming language.

In embodiments, member devices 102-104 may be further configured to receive a message from another computing device employing another mechanism, including, but not limited to email, Short Message Service (SMS), Multimedia Message Service (MMS), instant messaging (IM), internet relay chat (IRC), mIRC, Jabber, and the like or a Proprietary protocol.

In embodiments, network 105 may be configured to couple one computing device to another computing device to enable them to communicate. In some embodiments, network 105 may be enabled to employ any form of computer readable media for communicating information from one electronic device to another. Also, in embodiments, network 105 may include a wireless interface, and/or a wired interface, such as the Internet (e.g., so-called Internet cloud network), in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

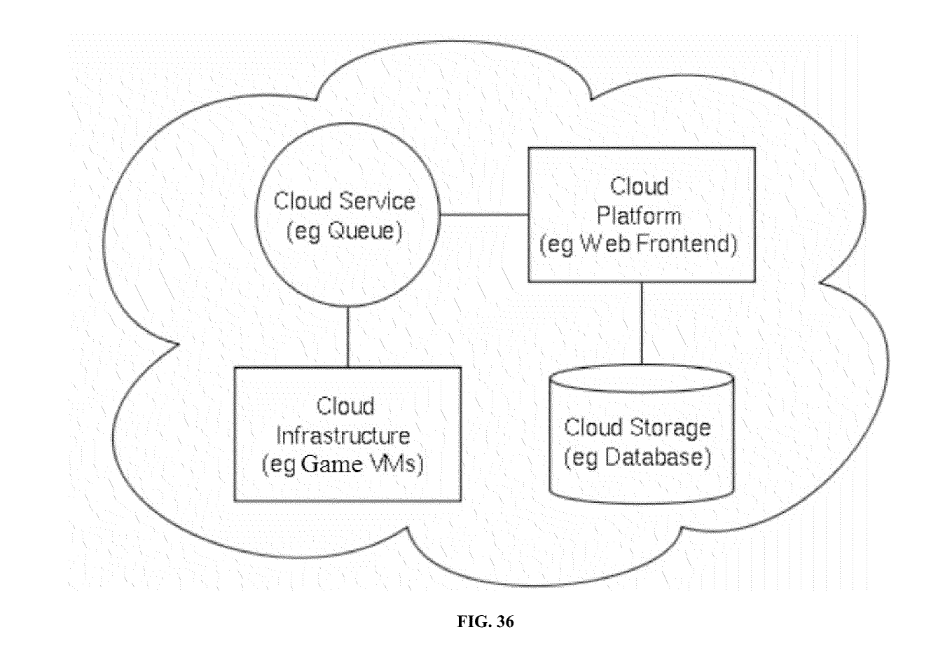

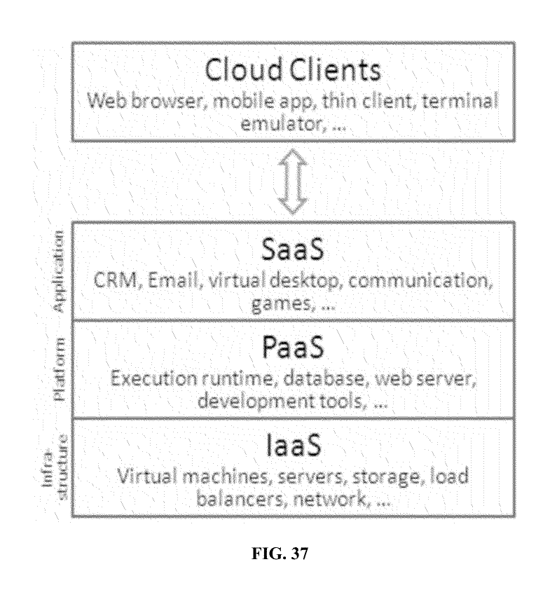

For purposes of the instant description, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user). In some embodiments, the instant invention offers/manages the cloud computing/architecture as, but not limiting to: infrastructure a service (IaaS), platform as a service (PaaS), and software as a service (SaaS). FIGS. 36-37 illustrate schematics of exemplary implementations of the cloud computing/architecture.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

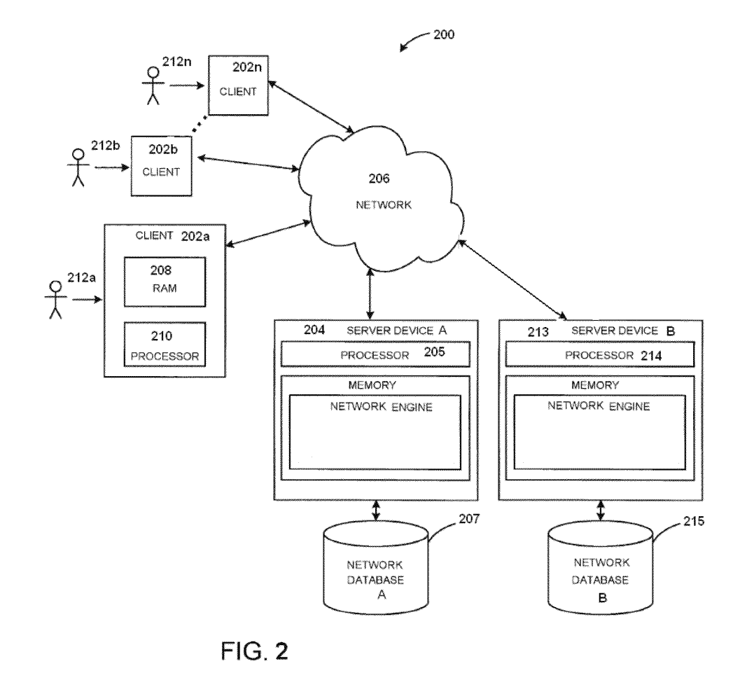

FIG. 2 shows another exemplary embodiment of the computer and network architecture that supports the inventive methods and systems. The member devices 202a, 202b thru 202n shown (e.g., computer/mobile devices of game developers, players, investors, etc.), each at least includes a computer-readable medium, such as a random access memory (RAM) 208 coupled to a processor 210 or FLASH memory. The processor 210 may execute computer-executable program instructions stored in memory 208. Such processors comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, a client device 202a may be any type of processor-based platform that is connected to a network 206 and that interacts with one or more application programs. Client devices 202a-n may operate on any operating system capable of supporting a browser or browser-enabled application, such as Microsoft™, Windows™, or Linux. The client devices 202a-n shown may include, for example, personal computers executing a browser application program such as Microsoft Corporation's Internet Explorer™, Apple Computer, Inc.'s Safari™, Mozilla Firefox, and Opera. Through the client devices 202a-n, users (e.g., game developers, players, investors, etc.) 212a-n communicate over the network 206 with each other and with other systems and devices coupled to the network 206. As shown in FIG. 2, server devices 204 and 213 may be also coupled to the network 206.

In some embodiments, the term “mobile electronic device” may refer to any portable electronic device that may or may not be enabled with location tracking functionality. For example, a mobile electronic device can include, but is not limited to, a mobile phone, tablet, Personal Digital Assistant (PDA), Blackberry™, Pager, Smartphone, or any other reasonable mobile electronic device. For ease, at times the above variations are not listed or are only partially listed, this is in no way meant to be a limitation.

In some embodiments, the terms “proximity detection,” “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

In some embodiments, near-field wireless communication (NFC) can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less.

In some embodiments, NFC may operate at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable devices are within close proximity of each other.

### Illustrative Examples of the Inventive Virtual Gaming Platform for Collaborative Game Development and Uses Thereof

In some embodiments, the inventive virtual gaming platform and the inventive methods/systems of implementing thereof incorporate the Internet and mobile media.

For purposes of some embodiments, the terms “game” or “games” mean electronic game(s), including software and hardware, that involve(s) one or more participants (players) engaged in activity(ies) based on rules. In some embodiments, the rules are pre-determined (static rules). In some embodiments, the rules are evolving during a game (dynamic rules). In some embodiments, based on the rules, some player(s) can be considered winner(s) or loser(s).

For purposes of the instant description, the terms “virtual gaming platform(s)” and “virtual gaming” correspond to at least one of the following: (1) a web-based online gaming platform for game development, game lifecycle management, and/or game playing, (2) a web-based online gaming for game development, game lifecycle management, and/or game playing, (3) an applet-based gaming platform for game development, game lifecycle management, and/or game playing, (4) an applet-based gaming for game development, game lifecycle management, and/or game playing, and (5) any other similarly suitable computer-generated gaming platform and computer-generated gaming environment for game development, game lifecycle management, and/or game playing.

In some embodiments, the inventive virtual gaming platform and the inventive methods/systems utilize social aspect of the Internet to allow participants to collaborate on some of all aspects of product life cycle of game(s): generating/selecting idea for a game, creating software/hardware, testing, implementing, financing (e.g., funding, angel investors, crowd funding, etc.), promoting, sharing, selling, reviewing, playing, and other activities related to the game's life cycle (development/introduction stage, growth stage, maturity stage, and decline stage).

In some embodiments, the inventive virtual gaming platform and the inventive methods/systems are technology agnostic (adaptable to any platform and/or Internet technology). In some embodiments, the inventive virtual gaming platform and the inventive methods/systems allow participants share games within the environment of the inventive virtual gaming platform with other participants on the service or a social networking services for free or for a fee.

In some embodiments, the inventive virtual gaming platform and the inventive methods/systems allow an individual user/participant and/or a group of users/participants to brainstorm idea(s) for a game (e.g., a community-driven game idea generation). In some embodiments, the inventive virtual gaming platform and the inventive methods/systems allow an individual user/participant and/or a group of users/participants to become collaborators in developing the game whether or not they came up with the concept of the game (e.g., a community-driven game development). In some embodiments, the inventive virtual gaming platform and the inventive methods/systems provide tools to users to develop software/hardware for the game. In some embodiments, the inventive virtual gaming platform and the inventive methods/systems allow an individual user/participant and/or a group of users/participants, who may have dissimilar interest, to collaborate in one or more aspect of the game's life cycle (development/introduction stage, growth stage, maturity stage, and decline stage).

In some embodiments, the instant invention includes an illustrative method for community game development and community management of game lifecycle that includes offering, by an illustrative specifically programmed virtual gaming platform, at least one first personalized computer interface to each of at least 1,000 users of an virtual game community managed by the specifically programmed virtual gaming platform.

In some embodiments, the at least one first computer interface is configured to allow each of the at least 1,000 users to create at least one game idea to the virtual game community. In some embodiments, the illustrative specifically programmed virtual gaming platform is configured to concurrently receive the at least one game idea from each of the at least 1,000 users of the virtual game community.

For purposes of the instant description, the term “game idea(s)” corresponds to at least one of the following: (1) an idea about a game that differs substantially or in any way from any game that is publicly known prior to the idea being expressed; (2) an idea about a game that combines one or more known functionalities of other known and/or unknown games in a manner that was not publicly known prior to the idea being expressed; and (3) an idea about any game. In some embodiments, the game idea(s) can be, for example, expressed as text, drawing(s), picture(s), sound(s), software code, software animation(s), or any combination thereof

In some embodiments, the specifically programmed virtual gaming platform is configured to automatically output, in real-time, a first plurality of game selections during creation of the at least one game idea based, at least in part, on data collected about the virtual game community. In some embodiments, the specifically programmed virtual gaming platform is configured to automatically output, in real-time, a first plurality of game selections during creation of the at least one game idea based, at least in part, on data collected about the virtual game community and/or any 3^{rd} party sources (e.g., social networks, gaming publications, industry sources, demographic sources, marketing sources, consumer surveys, etc.).

In some embodiments, the specifically programmed virtual gaming platform receives game idea votes on each submitted game idea of the plurality of game ideas. In some embodiments, the term “game idea vote(s)” corresponds to any support/comment/vote given by users belonging to a virtual gaming community managed by the specifically programmed virtual gaming platform or any 3^{rd} party individual or entity (e.g., Facebook users who are non-members of the gaming community).

In some embodiments, the specifically programmed virtual gaming platform automatically ranks at least one of: game ideas, games, games updates, games reviews, games improvements, etc.—based support/comment/vote received from at least one of the following:
users belonging to a virtual gaming community managed by the specifically programmed virtual gaming platform,
users belonging to the virtual gaming community who have also submitted at least one of: their own game ideas, their games, their games updates, their games reviews, their games improvements, etc.,
any 3^{rd} party individual or entity (e.g., separated crowdsourcing such as Facebook users who are non-members of the gaming community),
independent judge(s) who is/are at least one of the following: (1) selected by users belonging to the virtual gaming community, (2) selected by users belonging to the virtual gaming community and have not submitted games ideas, games, games updates, games reviews, games improvements, etc., 3) industry veteran(s), 4) automatically identified by the specifically programmed virtual gaming platform based on one or more pre-determined criteria about one of education, skills, industry experience, social popularity, and other similarly suitable criteria.

In some embodiments, the specifically programmed virtual gaming platform automatically selects at least one of: game ideas, games, game updates, game reviews, game improvements, etc.,—based on their corresponding ranking

In some embodiments, the specifically programmed virtual gaming platform automatically identifies at least one first game developer whose at least one skill is suited for development of at least one of: game ideas, games, games updates, games improvements, etc.,—by matching at least one characteristic of the at least one of: game ideas, games, game updates, game improvements, etc.,—with information about skills possessed by game developers who are registered with the virtual gaming community. In some embodiments, the specifically programmed virtual gaming platform automatically identifies at least one first game developer whose at least one skill is suited for development of at least one of: game ideas, games, game updates, game improvements, etc.,—by matching at least one characteristic of the at least one of: game ideas, games, game updates, game improvements, etc.,—with information about skills possessed by game developers who are not registered with the virtual gaming community.

In some embodiments, the information about skills possessed by game developers can be gathered by skills surveys to game developers and/or obtain from the third party electronic sources (e.g., LinkedIn, Monster.com, Freelance.com, Freelancer.com, Indeed.com, Elance.com, etc.).

In some embodiments, the specifically programmed virtual gaming platform is utilized to receive funds for developing at least one of a game idea, a game, a game update, games improvements, etc. the funds are at least partially provided by user(s) of the virtual game community. In some embodiments, the funds are at least partially provided by non-user(s) of the virtual game community. In some embodiments, the funds are provided by both user(s) and non-user(s) of the virtual game community. In some embodiments, both user(s) and non-user(s) can be a hedge fund, an angel investor, a corporation, a bank, etc.

In some embodiments, the specifically programmed virtual gaming platform receives game developer votes on the plurality of game developers identified by the by the specifically programmed virtual gaming platform. In some embodiments, the specifically programmed virtual gaming platform ranks the plurality of game developers based, at least in part, on the game developer votes. In some embodiments, the specifically programmed virtual gaming platform selects at least one winning game developer to develop the at least one winning game based, at least in part, on the ranking the plurality of game developers.

In some embodiments, the specifically programmed virtual gaming platform receives game comments (e.g., test comments, debugging comments, etc.) during the development of the at least one winning game (e.g., comments can be from user(s) and/or non-user(s) of the virtual game community, independent judges, non-submitting users of the virtual game community, etc.). In some embodiments, the specifically programmed virtual gaming platform receives game comment votes on the comments about the development of the at least one winning game. In some embodiments, the specifically programmed virtual gaming platform ranks the game comments on at least one of the game comment votes, independent judges' reviews, etc. In some embodiments, the specifically programmed virtual gaming platform selects at least one winning feature to be incorporated into the at least one winning game based, at least in part, on the ranking the game comments.

In some embodiments, the specifically programmed virtual gaming platform receives game reviews (e.g., reviews can be from user(s) and/or non-user(s) of the virtual game community, independent judges, non-submitting users of the virtual game community, etc.).

In some embodiments, the specifically programmed virtual gaming platform receives review votes on the game reviews. In some embodiments, the specifically programmed virtual gaming platform ranks the game reviews on at least one of the game comment votes, independent judges' reviews, etc.; and selects what game review to act upon (e.g., initiate update, add feature, launch new promotion, etc.).

In some embodiments, the inventive virtual gaming platform and the inventive methods/systems allow an individual user/participant and/or a group of users/participants to vote and comment on published ideas and gaming prototypes. In some embodiments, successful game ideas or concepts and game prototypes, pass the review phase and go to either the game development (for game ideas) or game sharing (for games).

In some embodiments, for non-completed games (games under development), the inventive virtual gaming platform and the inventive methods/systems allow an individual user/participant and/or a group of users/participants, who are not participating in the development process, to access the game so as to test, debug, improve or review the game and/or game idea under development. In some embodiments, for completed games, the inventive virtual gaming platform and the inventive methods/systems allow an individual user/participant and/or a group of users/participants, who did not participate in the development process, to play the game either for free or with a fee.

For purposes of the instant description, the term “game project(s)” corresponds to a work and/or work product in any part of a lifecycle of developing, launching, and/or managing the playing of a game by user(s); including, but not limiting to, at least one of the following: (1) a game idea; (2) a game prototype; (3) a play of a game, etc. In some embodiments, the inventive virtual gaming platform and the inventive methods/systems allow an individual user/participant and/or a group of users/participants, who did not participate in the creation and/or development process, to do at least one of the following, which is not limiting,: buy and/or exchange a game project (buy the exclusivity of a game idea and/or game prototype); buy and/or exchange game components (i.e., buy avatars, game templates, etc.) and/or any stage of game life cycle; fund a game project, game components and/or any stage of game life cycle; barter/exchange a game project, game components and/or any stage of game life cycle; bid in an auctioning system for a game project, game components and/or any stage of game life cycle; and/or provide private funds to a game project, game components and/or any stage of game life cycle.

In some embodiments, the inventive virtual gaming platform and the inventive methods/systems allow an individual user/participant and/or a group of users/participants to profile (e.g., through market research) at any stage of the game life cycle (from the conception/idea and on) targeted audience for the game, potential interest in the game, specific demographics characteristic(s), specific geographic characteristic(s), and other similar objective(s).

In some embodiments, the inventive virtual gaming platform and the inventive methods/systems allow an individual user/participant and/or a group of users/participants to play free games, game demos, and/or fee-based games.

In some embodiments, the inventive virtual gaming platform and the inventive methods/systems allow an individual user/participant and/or a group of users/participants to play games with both registered and unregistered members of the community of the inventive virtual gaming platform.

In some embodiments, the inventive virtual gaming platform and the inventive methods/systems allow an individual user/participant and/or a group of users/participants to engage in game generation, development and the others aspects of game life cycle by providing game or idea development options and/or tools. For example, in some embodiments, the inventive virtual gaming platform and the inventive methods/systems allow an individual user/participant and/or a group of users/participants to, for a game proposal and/or prototype, to, but not limiting to,:
edit their game idea and/or game prototype (i.e., modify and further develop);
publish their game idea for community support (i.e., creators seek the community support for their game and publish their game prototype for:

(a) game testing (e.g., beta testing within the community),

(b) game playing among community; and/or

(c) community support (e.g., financing, advance purchase orders, etc.).

In some embodiments, the inventive virtual gaming platform and the inventive methods/systems allow an individual user/participant and/or a group of users/participants to facilitate game idea generation through several provided tools/templates. For example, in some embodiments, the inventive virtual gaming platform and the inventive methods/systems allow each tool/template to be customized to address categories of users with diverse computer, gaming, and/or game design skills. For example, in some embodiments, the inventive virtual gaming platform and the inventive methods/systems allow its users to incorporate new tools and/or templates that are being offered by the inventive virtual gaming platform.

In some embodiments, the inventive virtual gaming platform and the inventive methods/systems include decision making tools, including, but not limited to, tools for voting, weighted voting, task partitioning and/or assignment. In some embodiments, the inventive virtual gaming platform and the inventive methods/systems include decision making tools that offer conflict resolutions protocols/rules among group members and facilitate the rapid advancement of the game idea and/or game.

In some embodiments, the inventive virtual gaming platform and the inventive methods/systems allow an individual user/participant and/or a group of users/participants to participate in a game marketplace where individual and corporate users of the community can: buy, sell, auction and crowd-fund game ideas, game prototypes, game components, game templates and game content (e.g., game figures/characters, etc.). In some embodiments, the inventive virtual gaming platform and the inventive methods/systems allow an individual user/participant and/or a group of users/participants to outsource activities such as game development, game template development, game content development, etc.

In some embodiments, the inventive virtual gaming platform and the inventive methods/systems include a distributed (e.g., Internet cloud-based) computer system/platform. In some embodiments, the inventive virtual gaming platform and the inventive methods/systems allow an individual user/participant and/or a group of users/participants to submit their game/tools/services plug-ins for testing through an additional option offered by the inventive virtual gaming platform (e.g., through the Game Design and Development Module). In some embodiments, the inventive virtual gaming platform and the inventive methods/systems allow an individual user/participant and/or a group of users/participants to develop their plug-ins by utilizing APIs (Application Programming Interface) pre-set routines offered to them by the inventive virtual gaming platform and the inventive methods/systems.

In some embodiments, the inventive virtual gaming platform and the inventive methods/systems allow an individual user/participant and/or a group of users/participants to export the developed game(s) (e.g., software code) as, for example, a single source code/file that can be executed on all supported/targeted platforms.

In some embodiments, the inventive virtual gaming platform and the inventive methods/systems provide ability to adapt game software to run on future gaming computing platforms.

In some embodiments, the inventive virtual gaming platform and the inventive methods/systems allow an individual user/participant and/or a group of users/participants to collaborate in the inventive virtual gaming platform/community by utilizing desktop and/or portable computing devices (e.g., smart phones) remotely through the Internet, intranet, and/or extranet.

In some embodiments, the inventive virtual gaming platform and the inventive methods/systems allow to incorporate existing and/or future external game engines which can be proprietary and/or open source.

In some embodiments, the inventive virtual gaming platform and the inventive methods/systems allow to incorporate interfaces, either open source or proprietary, for the communication with third party infrastructures, existing or under development, that aid the game development process or provide services for games.

In some embodiments, the inventive virtual gaming platform and the inventive methods/systems allow to provide services and infrastructure to the users in order to assist the prototyping, scaling, and/or connectivity of their games.

In some embodiments, the inventive virtual gaming platform and the inventive methods/systems provide an open social gaming ecosystem for user-generated game development and community game playing. In some embodiments, the inventive virtual gaming platform and the inventive methods/systems facilitate the rapid development of game concepts into open peer-to-peer game projects that can run over multiple hardware platforms through the provision of libraries and collaborative development tools. In some embodiments, the community-driven ideas are peer-evaluated, and the most interesting ones (e.g., ranked higher, more feedback, etc.) are selected to be developed by either the submitter and/or members of the broader user community, which can include both individuals and corporations. In some embodiments, the inventive virtual gaming platform and the inventive methods/systems provide a centralized marketplace (e.g., the Internet Cloud store) to try-out, test, download, and/or play the developed game(s). In some embodiments, the inventive virtual gaming platform and the inventive methods/systems promote one or more of the following social interactions, but not limiting to,:

user-to-user,

user-to-community,

user-to-company, and/or

company-to-company.

In some embodiments, the inventive virtual gaming platform and the inventive methods/systems include, but not limited to, a plurality of the following components:

(a) User profiling module,

(b) Game idea generation module,

(c) Game design and development module,

(d) Community module,

(e) Game store module,

(f) Game play module, and

(g) Marketplace module.

In some embodiments, the inventive virtual gaming platform and the inventive methods/systems incorporate a financial aspect to the developed games—e.g., develop games that offer money wagering and/or paying out monetary rewards/prizes. In some embodiments, the inventive virtual gaming platform and the inventive methods/systems offer a community currency. In some embodiments, the inventive virtual gaming platform and the inventive methods/systems developers/sponsors a capability to specify whether the virtual currency can be converted in real currency (e.g., $ US dollar, yen, euro, British pound, etc.) and at what rate. In some embodiments, the inventive virtual gaming platform and the inventive methods/systems offer a goods/services marketplace to redeem the virtual currency. In some embodiments, the inventive virtual gaming platform and the inventive methods/systems utilize a mobile application such as Google Wallet or equivalent in financial transactions that support games having the financial aspect (e.g., wagering, payment, etc.).

In some embodiments, the inventive virtual gaming platform and the inventive methods/systems platform is an all-in-one solution that covers the entire life cycle of gaming. In some embodiments, the inventive virtual gaming platform and the inventive methods/systems define a complete, web-based system with services and functionality that support the game development process from the generation of the game idea to the actual development of the ideas into game (through appropriate development tools) as well as the game distribution and game playing. In some embodiments, the inventive virtual gaming platform and the inventive methods/systems functionality and services are available and accessible online by a computer device, such as a mobile computer device.

In some embodiments, the inventive virtual gaming platform and the inventive methods/systems do not require users to install specific hardware or software for the design, development, playing and distribution of the games and ideas. In some embodiments, the inventive virtual gaming platform and the inventive methods/systems platform creates and supports its own user community which includes, but not limited to, designers, developers, investors, players, etc.

In some embodiments, the inventive virtual gaming platform and the inventive methods/systems provide mechanisms for sharing ideas for game(s) and developing those ideas by appropriate users, who can be other than idea generators, that can then translate ideas into actual games. In some embodiments, the inventive virtual gaming platform and the inventive methods/systems accelerate the production cycle for new ideas and games.

In some embodiments, the inventive virtual gaming platform and the inventive methods/systems provide tools to design games that are simple, do not require a lot of playing time, and can be played on any browser without significant requirements of computational power and memory.

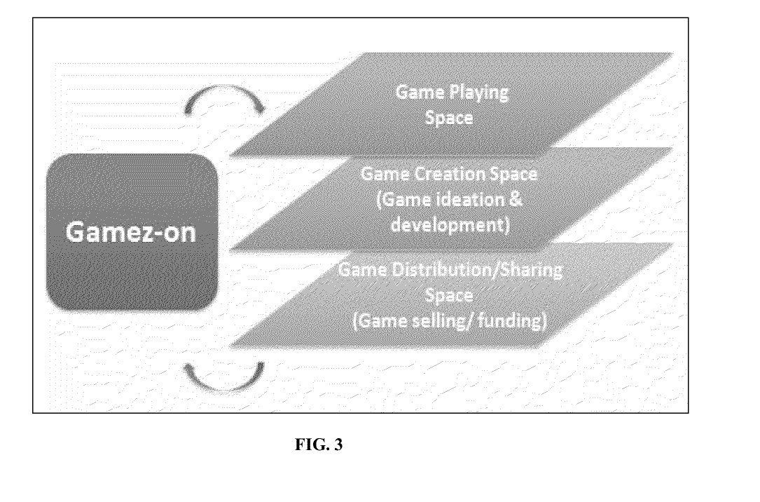

In some embodiments, the inventive virtual gaming platform and the inventive methods/systems provide tools to build location based services into games. In some embodiments, the inventive virtual gaming platform and the inventive methods/systems provide an intelligent, community-driven game idea generation and development environment driven by the dynamics of social networks and communities by providing code libraries and collaborative development tools. In some embodiments, the inventive virtual gaming platform and the inventive methods/systems allow an individual user/participant and/or a group of users/participants to utilize existing social networks (i.e., facebook, Myspace, twitter, etc) to support its activities throughout the inventive virtual gaming platform. FIG. 3 shows an exemplary diagram of an embodiment of the inventive virtual gaming platform, labeled as “Gamez-on” for purposes of this description therein, but not limited to.

Open source software (OSS) is computer software that is available with source code: the source code and certain other rights normally reserved for copyright holders are provided under an open source license that permits users to study, change, improve and at times also to distribute the software.

In some embodiments, the inventive virtual gaming platform and the inventive methods/systems are designed to be inclusive, participative, open, and user-centered. In some embodiments, the inventive virtual gaming platform and the inventive methods/systems are designed to be the Open source software and hardware environment which means that the users are provided with source code under an open source license that permits users to study, change, improve, and/or distribute the software.

In some embodiments, the inventive virtual gaming platform and the inventive methods/systems can include several functional components, denoted as modules, each of which provides and supports a distinct and/or joint functionality(ies):

1) The User Profiling Module: this module is the initial access point of the inventive virtual gaming platform (e.g., “Gamez-On”). It provides all the necessary functionality for creating a detailed user profile that corresponds to user's preferences, gaming needs and characteristics.

2) The Community Module: this module is the social place of the inventive virtual gaming platform. It provides services similar to the ones provided by well-known social networks.

3) The Game Idea Generation Module: this module allows and supports the creating and exchange of new game ideas that can be then formed in games.

4) The Game Design and Development Module: this module allows and supports the actual design and development of new games, by providing users with a variety of game development options and game engines.

5) The Game Store Module: this module presents the games developed by members of the inventive virtual gaming platform and the inventive methods/systems application as well as links to other well-known game stores (according to the characteristics of each game developed).

6) The Game Play Module: this module presents a variety of games, among which the users can select for online playing.

7) The Marketplace Module: this module allows individual and corporate users to: buy, sell, and/or crowdfund game ideas, game prototypes, game components, game templates and game content (i.e., game characters/figures etc.). This module allows users to outsource different activities such as game development, game template development, game content development, etc.

In some embodiments, the instant invention allows to develop a game when funds for development of the game and/or any other part of game lifecycle are equal or exceed a predetermined amount.

In some embodiments, the inventive virtual gaming platform and the inventive methods/systems support interconnectivity and exchange of information among the modules.

Exemplary Embodiments of the User Profiling Module

In some embodiments, this module constitutes the initial access point of the inventive virtual gaming platform. It provides all the necessary functionality for creating a detailed user profile that corresponds to each user's preferences, gaming needs and characteristics. More specifically, the User Profiling Module can track and monitor information about the following:

1) Standard Personal information for accessing and contacting the end user.

2) Game Development information for an initial evaluation of end user's skills in game design and development.

3) Game Preferences information for gathering user's preferences during game playing.

4) Social Preferences information for allowing users to set their visibility preferences and access to existing social networks they are members of

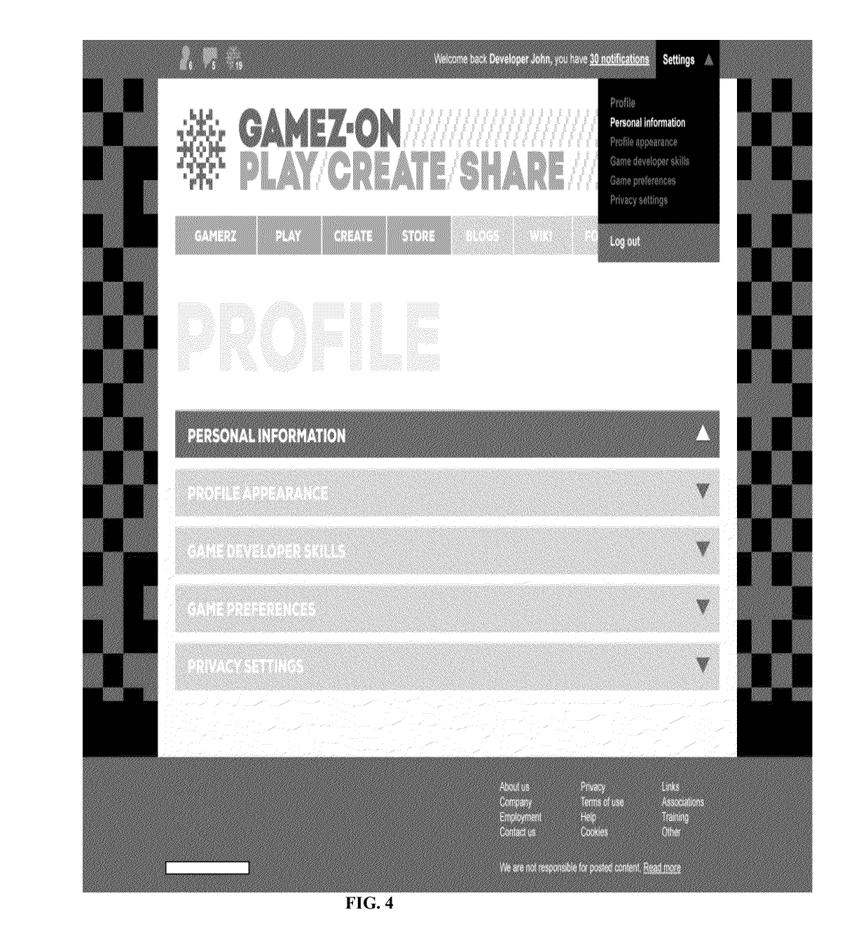

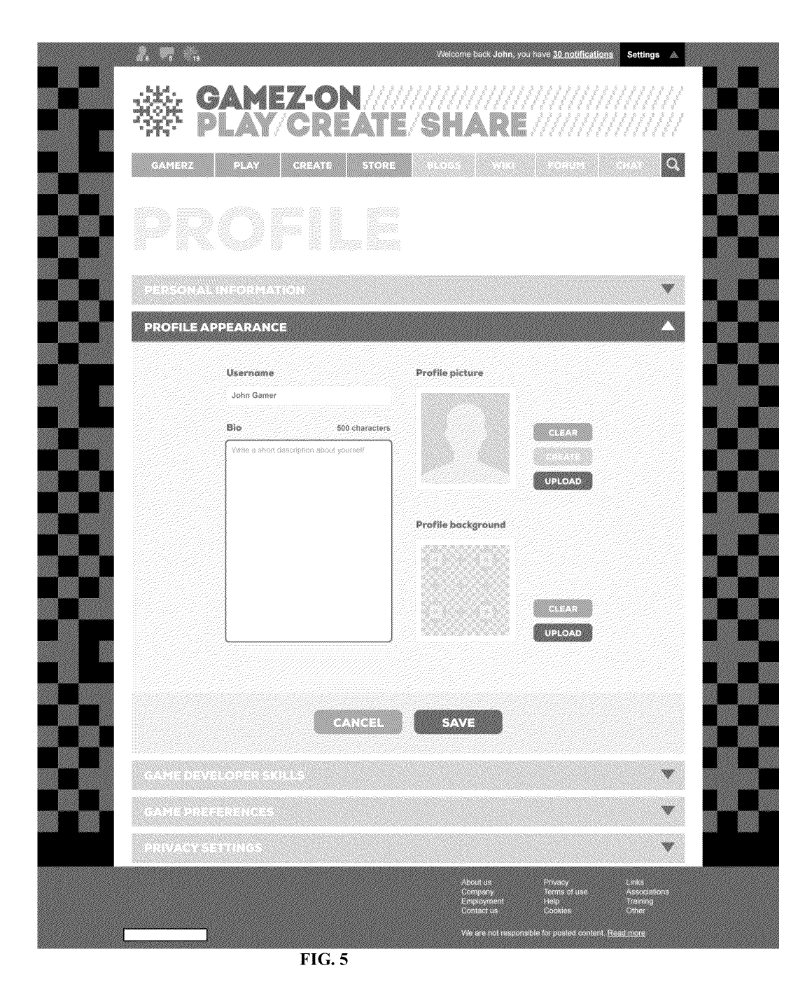

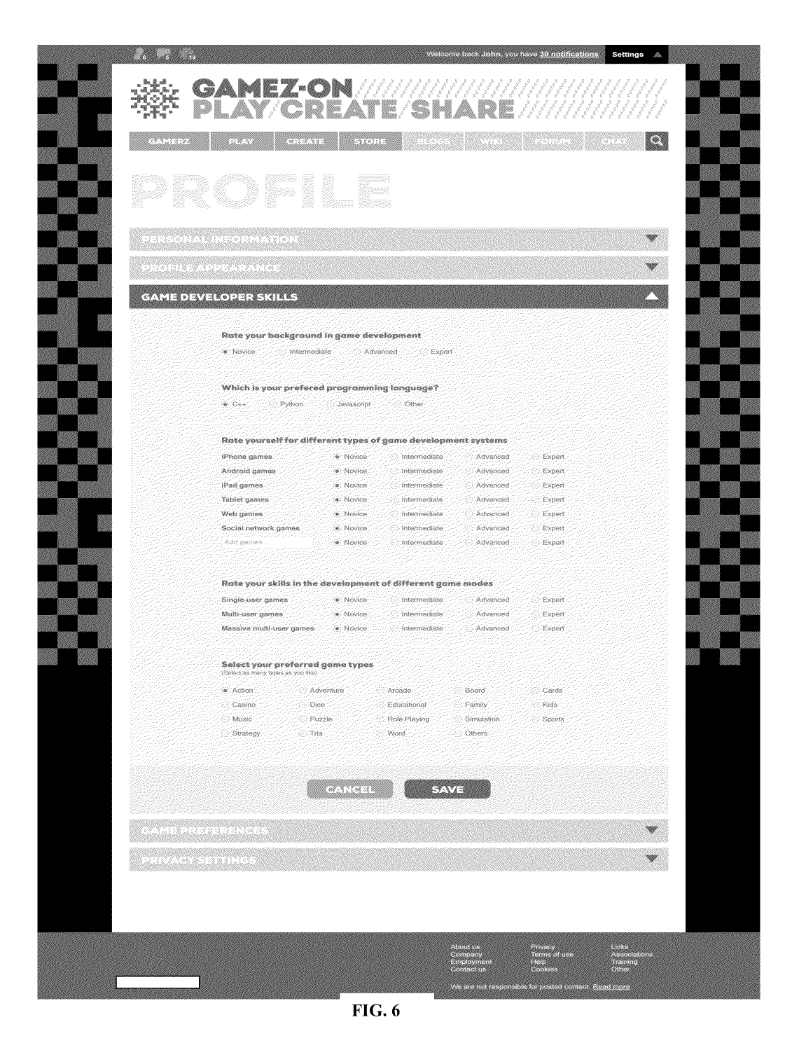

In some embodiments, the information gathered through the User Profiling Module serve as the basis for providing end users with personalized services. This information is later combined with information about users' activity within the system, is processed and updated so as to better reflect the individual characteristics, needs and preferences of each end user/member of the inventive virtual gaming platform. FIGS. 4-6 show exemplary screenshots illustrating certain features related to the User Profiling Module.

Exemplary Embodiments of the Community Module

In some embodiments, the inventive virtual gaming platform and the inventive methods/systems allow to manage size, distance, culture, skills, and/or technology in such a way as to leverage game idea generation and development. From families to friendships, users share experiences and interactions with groups. In some embodiments, the inventive virtual gaming platform and the inventive methods/systems system allows to maintain and exploit personal attachments within user groups and communities. In some embodiments, the Community module includes the following services:

1) Personal Activity-Timeline: The Personal Activity service provides a “log file” of all actions that each user performs within the community along with any type of reaction to the Community Activity of the user—the Community Activity service provides a “log file” of all actions that each user's close network performs within the community along with any type of reaction that these actions have drawn from other community users.

2) Friends' View: This service maintains and displays information for each user's network along with any new invitation sent to the user requesting access to his/her information.

3) Messages' View: This service provides to each individual user a type of “personal messages” functionality (e.g., e-mail communication etc.). Each user can receive, send and forward messages either from his/her network and/or from external members that the user is not yet linked with.

4) Groups' View: This service maintains and displays information for groups that the user has created and/or is a member of.

5) Notifications' View: The Notifications service of the Community Module lets users, automatically and real-time, know when people take actions related to those users, so they can, for example, promptly check out a new posting (e.g., comment on a game idea).

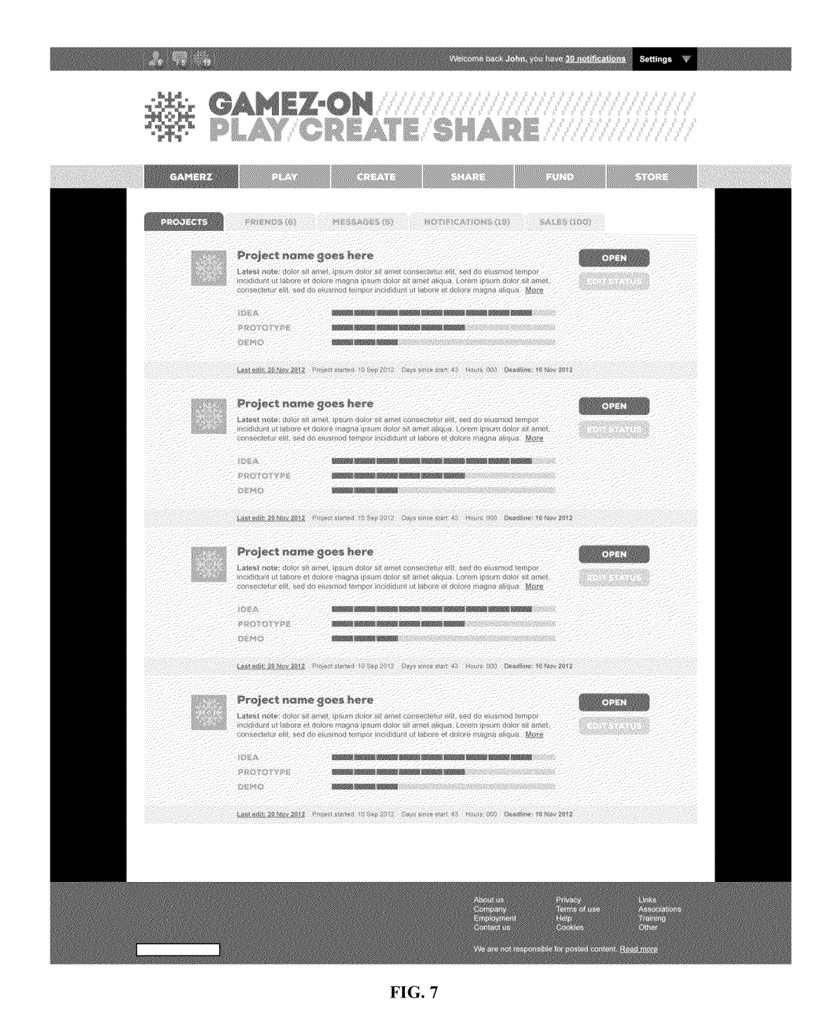

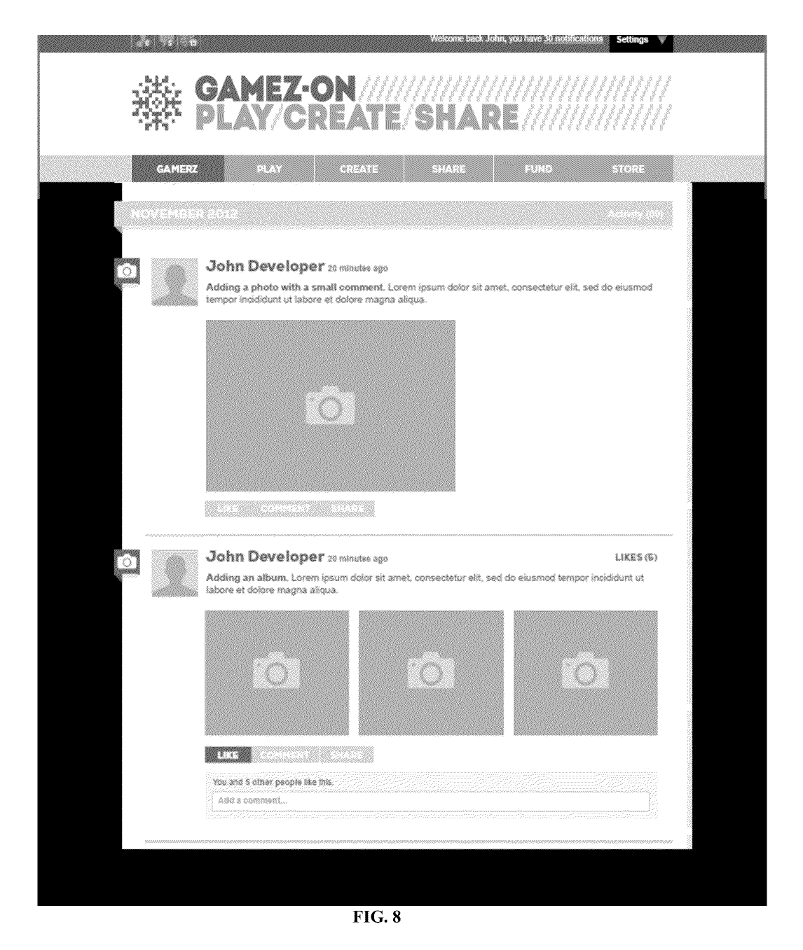

FIG. 7 shows an exemplary screenshot illustrating certain features related to the Community Mode: User's Activity Feed. FIG. 8 shows an exemplary screenshot illustrating certain features related to the Community Mode: User's Timeline.

Exemplary Embodiments of the Game Idea Generation Module

In some embodiments, the Game Idea Generation Module provides necessary functionality for idea creation and formulation both by individuals and groups within the inventive virtual gaming platform and can provide the following services, but not limited to:

1) The Personal Portfolio, where users can access all game ideas they have formed, either individually or as members of a team.

2) The Drafts section, where draft work on game ideas is stored.

3) Idea Setup services that provides all necessary functionality for idea formulation through different paths and alternatives. In some embodiments, the Idea Setup service of the Game Idea Generation Module allows the formation of game ideas in different forms, for example:

i) Plain Mode: The Plain Mode is the simplest form for expressing a game idea. The game idea is described in plain text.

ii) Template Mode: The Template Mode of the Idea Setup service provides a more structured form for game idea description. The template is frame-based, in terms that the user needs to describe among others the activities and media related to each stage/frame of the game.

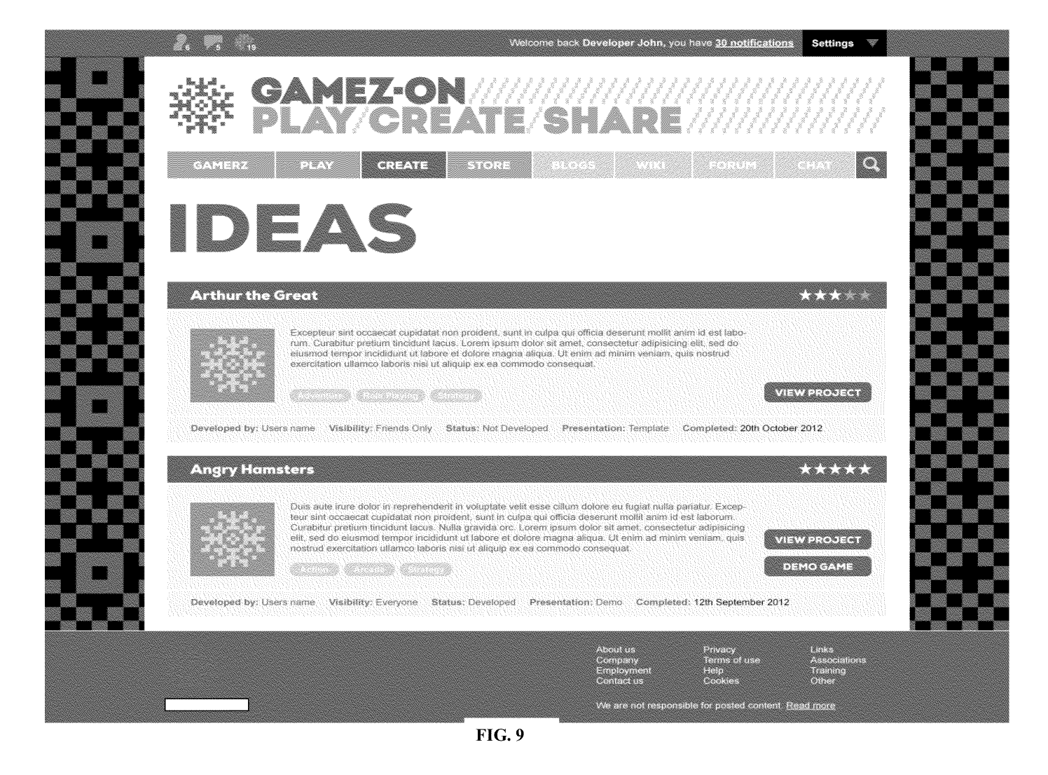

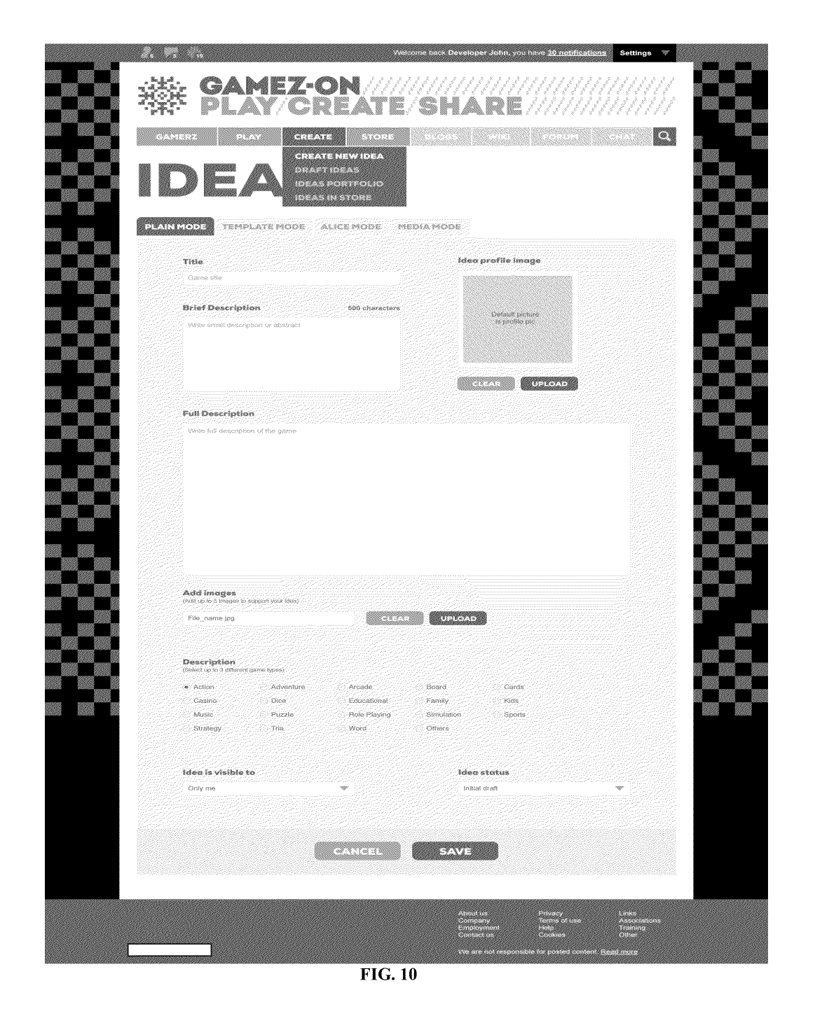

iii) Media File Mode: The Media File Mode allows users to describe their idea through a WYSIWYG (“What You See Is What You Get”)-like editor or program that allows a developer to see what the end result will look like while the interface or document is being created (e.g., an HTML WYSIWYG editor, such as Microsoft's FrontPage or Adobe's PageMill). The WYSIWYG implies the ability to directly manipulate the layout of a document without having to type or remember names of layout commands. The actual meaning depends on the user's perspective. Though this editor the users can describe with rich media ways to manipulate game models, game design and game actors. FIG. 9 shows an exemplary screenshot illustrating certain features related to the Game Idea Generation Module: Ideas Portfolio. FIG. 10 shows an exemplary screenshot illustrating certain features related to the Game Idea Generation Module: Idea Setup in Plain Mode.

Exemplary Embodiments of the Game Design and Implementation Module

In some embodiments, the Game Design and Implementation Module supports the actual design and development of game ideas, by providing users with a variety of game development options and/or game engines. In some embodiments, the game engines support export devices (e.g., Xbox, Wii, Apple, Android, and/or Windows smart phones, etc), game modes and graphical representations. In some embodiments, the Game Design and Implementation Module is an all-in-one solution, by integrating different gaming engines in universal game development environment. In some embodiments, the module supports the following services, but not limited to,:

1) The Game Portfolio, where users can access all games they have developed, either individually or as members of a team.

2) The Drafts section, where draft work on game development is stored.

3) New Game Setup that provides all necessary functionality for the initialization of a new game development. The users can have different skills and background (and therefore role(s)) in the game development. In some embodiments, the inventive virtual gaming platform supports user's interest in game development by offering options based, at least in part, on, but not limited to,:

i) Game Modes: Single-user games, multi-user games and massive multi-user games.

ii) Devices: iPhone, iPad, Android-based devices, web browsers.

iii) Representation Technology: 2D and/or 3D technology.

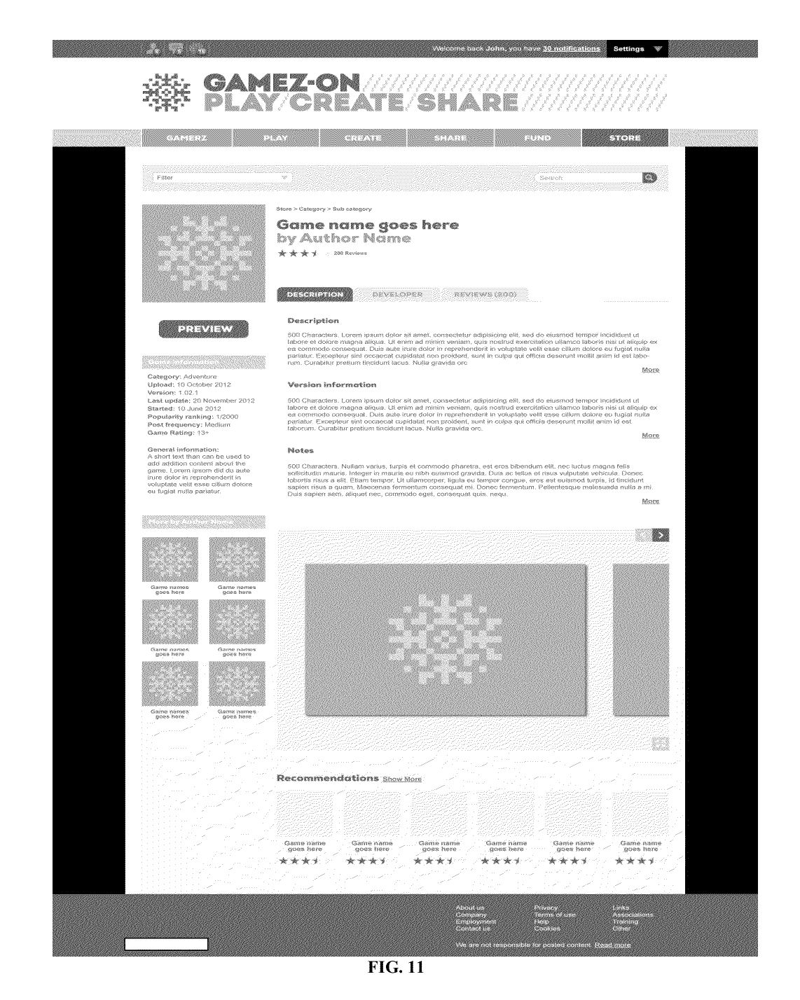

In some embodiments, the inventive virtual gaming platform and the inventive methods/systems system allow expert/sophisticate users, the Game Design and Development Module, to test and incorporate users' plug-ins as part of the development process. FIG. 11 shows an exemplary screenshot illustrating certain features related to the Game Design and Development Module: Finished Game Overview.

Exemplary Embodiments of the Game Store Module

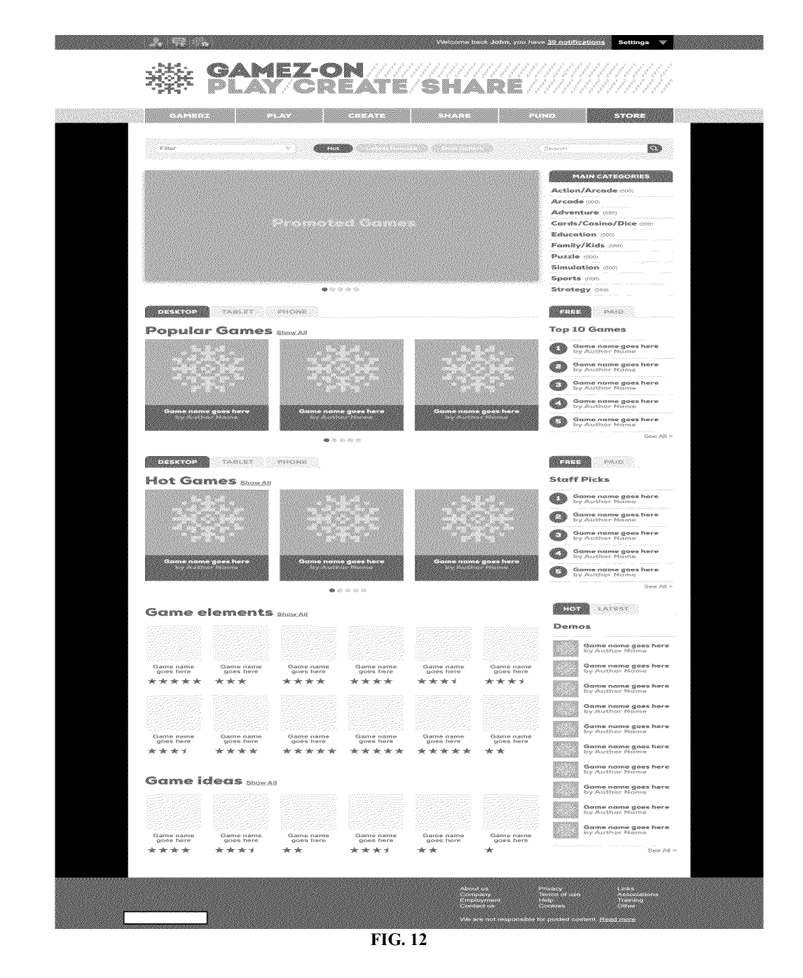

The Game Store Module presents the games developed utilizing the inventive virtual gaming platform of the instant invention as well as links to other well-known game stores (according to the characteristics of each game developed). In some embodiments, the Game Store can include both free and commercial games developed by the users. In some embodiments, the inventive virtual gaming platform and the inventive methods/systems provide a capability for automatically making games designed for distinct platforms (e.g., iPhone and iPad v. Windows 8) available in a standardized manner, by utilizing programmed wizards/interfaces. FIG. 12 shows an exemplary screenshot illustrating certain features related to the Game Store Module.

Exemplary Embodiments of the Game Play Module

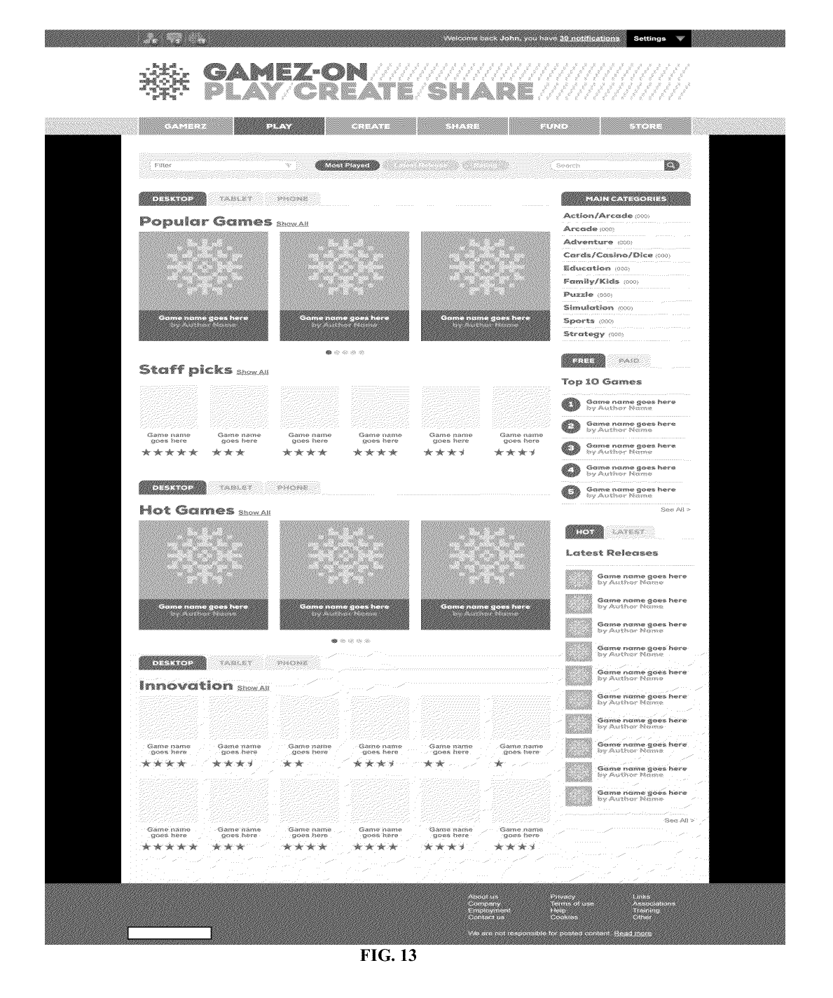

In some embodiments, the Game Play Module is a space of the inventive virtual gaming platform of the instant invention that users visit to play games developed within the inventive platform. In some embodiments, for multi-user game modes, the inventive virtual gaming platform of the instant invention allows users to invite friends from their network, who are currently online, and initiate a game play. FIG. 13 shows an exemplary screenshot illustrating certain features related to the Game Play Module.

Exemplary Embodiments of the Marketplace Module

In some embodiments, the Marketplace module is a space of the inventive virtual gaming platform of the instant invention where individual and corporate stakeholders are able to, but not limited to, do at least one of:

1) Buy/sell game ideas, game prototypes, game components, game templates and game content (e.g., game characters/figures etc.)

2) Auction game ideas, game prototypes, game components, game templates and game content (e.g., game characters/figures etc.)

3) Fund game ideas, game prototypes, game components, game templates and game content (e.g., game characters/figures etc.)

4) Crowdfund game ideas, game prototypes, game components, game templates and game content (e.g., game characters/figures etc.).

5) Outsource different activities such as game development, game template development, game content development etc.

Exemplary Embodiments of Communication and Collaboration Tools

In some embodiments, the inventive virtual gaming platform and the inventive methods/systems system can provide one or more of the following communication and collaboration tools to its users, but not limited to,:

1) Text Chat: Text-chat allows the text-based real-time communication among users that, for example, are connected either through “friendships” or as members of the same groups. In some embodiments, when a user connects (e.g., log-in) to the inventive virtual gaming platform, through the Chat service, she/he is able to view from her/his list of peers those that are online and send them instant messages. In some embodiments, the chat feature is automatically provided to each group and community created in the inventive virtual gaming platform.

2) Forums: Forums provide a digital space where members of the inventive virtual gaming platform can get and discuss issues related, among other, to game development, game ideas, coding etc. In some embodiments, the forum feature is automatically provided to each group and community created in the inventive virtual gaming platform.

3) Blogs: Blogs provides micro-sites for the members of the inventive virtual gaming platform and can be arranged in chronological order from the most recent ‘post’ (or entry) at the top of the main page to the older entries towards the bottom. In some embodiments, the blog feature is automatically provided to each group and community created in the inventive virtual gaming platform.

4) Wikis: Wikis allows members to create and/or edit content of the site from their own computer. In some embodiments, wikis provides members with the ability to write down quick ideas or longer ones, instantly collaborate and/or keep the groups in sync. In some embodiments, the Wikis feature is automatically provided to each group and community created in the inventive virtual gaming platform.

Exemplary Embodiments of the Back-end Processes

In some embodiments, the back-end processes of the inventive virtual gaming platform can monitor and/or track user activities on different elements of the system. In some embodiments, the back-end processes can gather information that can, automatically and/or in real-time, provide more personalized services to the users and/or improve the user experience. In some embodiments, the data gathered from these processes can be combined and analyzed to determine, for example, user and/or community trends, criteria and pattern matching, pre-populating (recommending) entries/choices to users, provide feedback for the inventive virtual gaming system automatic evolution by, for example, performing proactive activity such as incorporating external resource(s)/tools/services that the users search for and/or discuss in forums/blogs, etc. In some embodiments, these back-end monitoring processes can be divided in three categories:

1) User-Centric Monitoring Processes

2) Game-Centric Monitoring Processes

3) Idea-Centric Monitoring Processes

Exemplary Embodiments of the Inventive Virtual Game Platform Business System Architecture

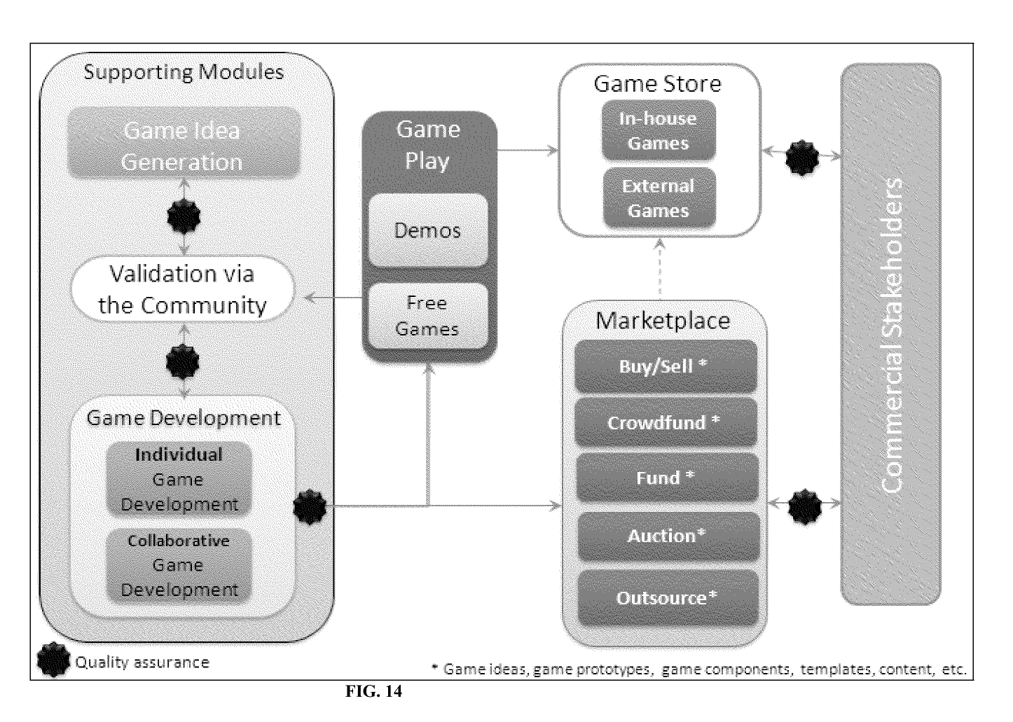

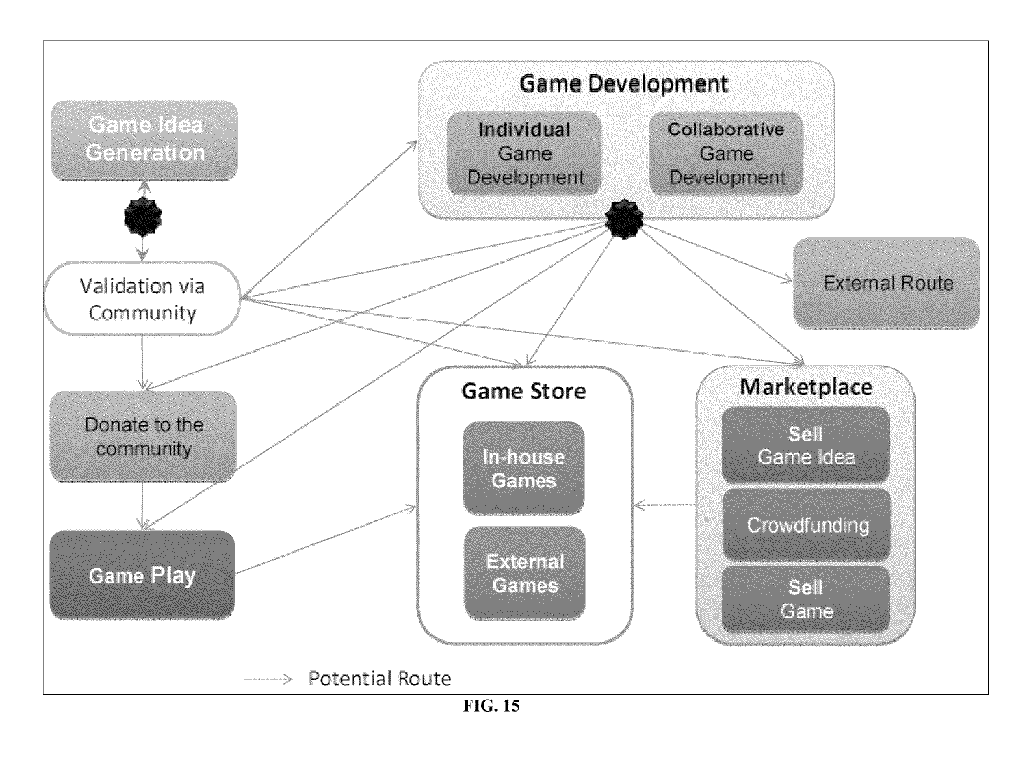

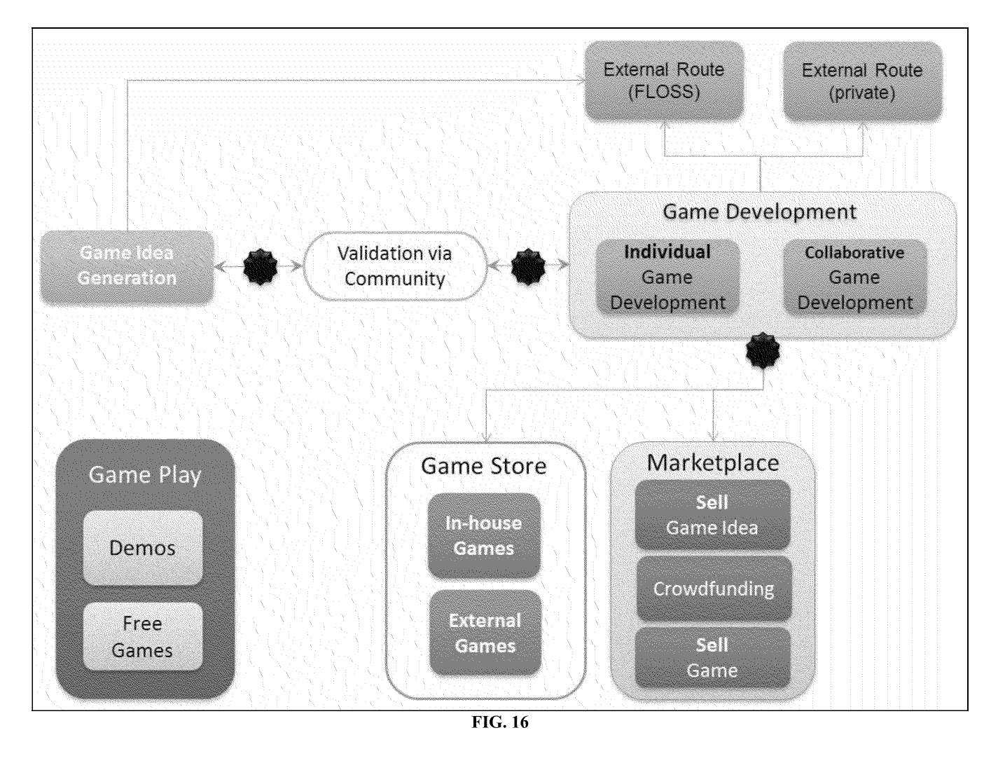

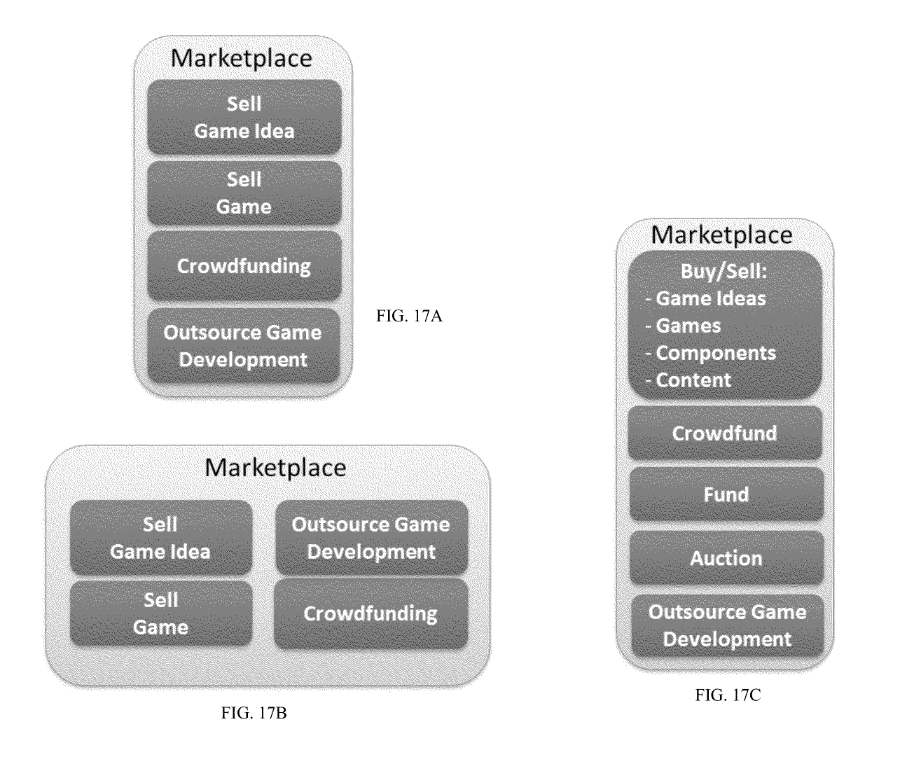

FIGS. 14-17C show schematic representations of exemplary system architectures of the inventive virtual gaming platform and computer methods/computer systems in accordance with some embodiments of the instant invention.

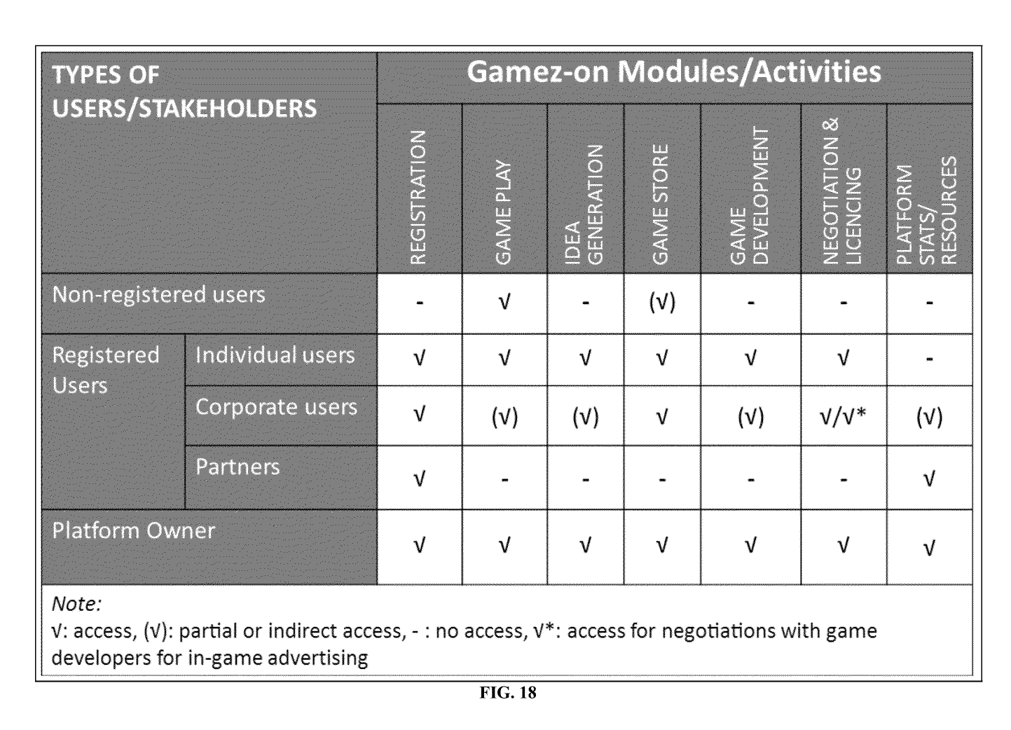

FIG. 18 shows a table that summarizes varied exemplary relationships and activities that different types users of the inventive virtual gaming platform can have in accordance with some embodiments.

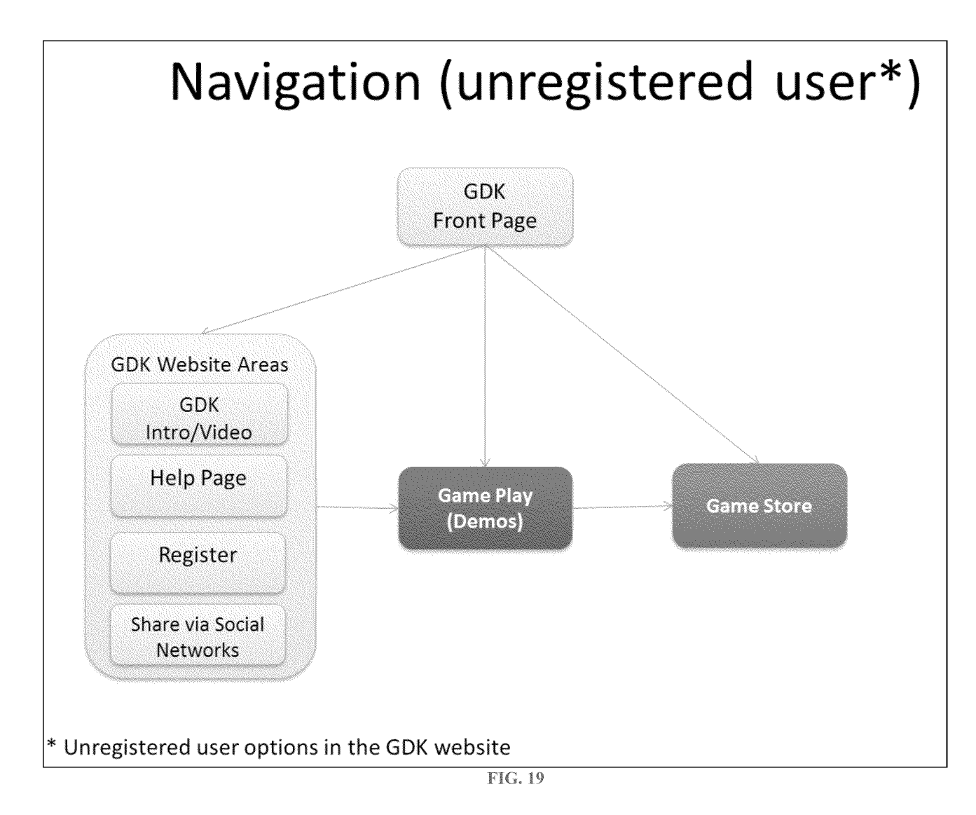

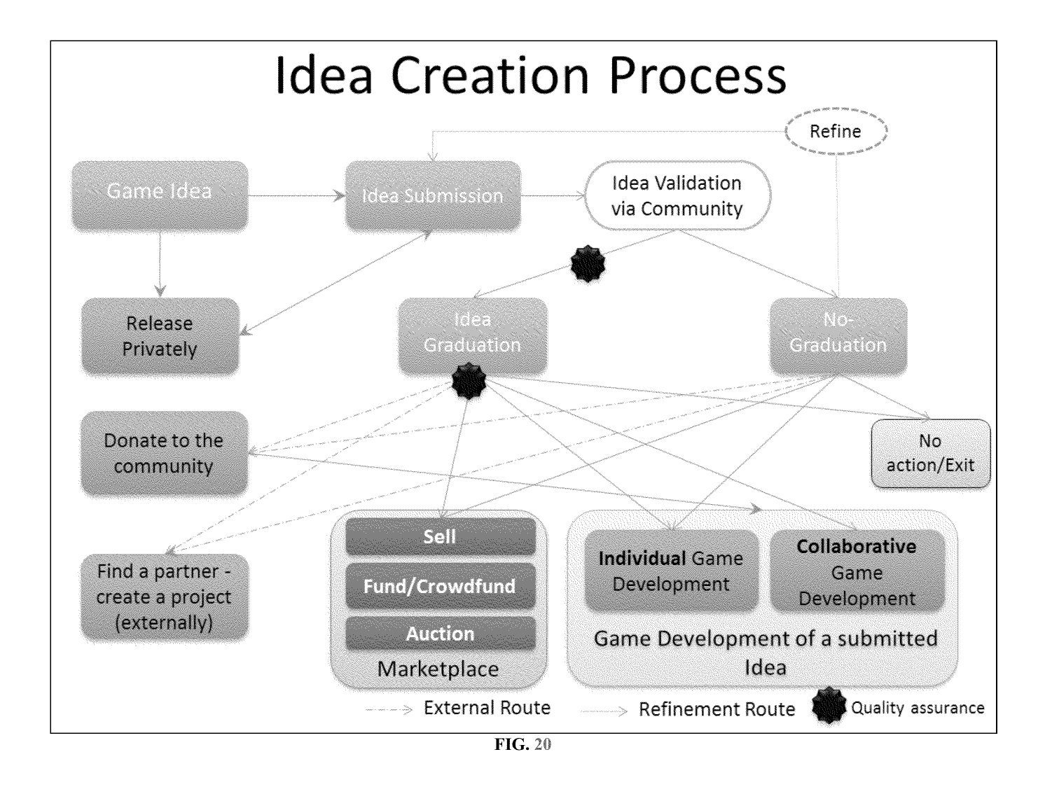

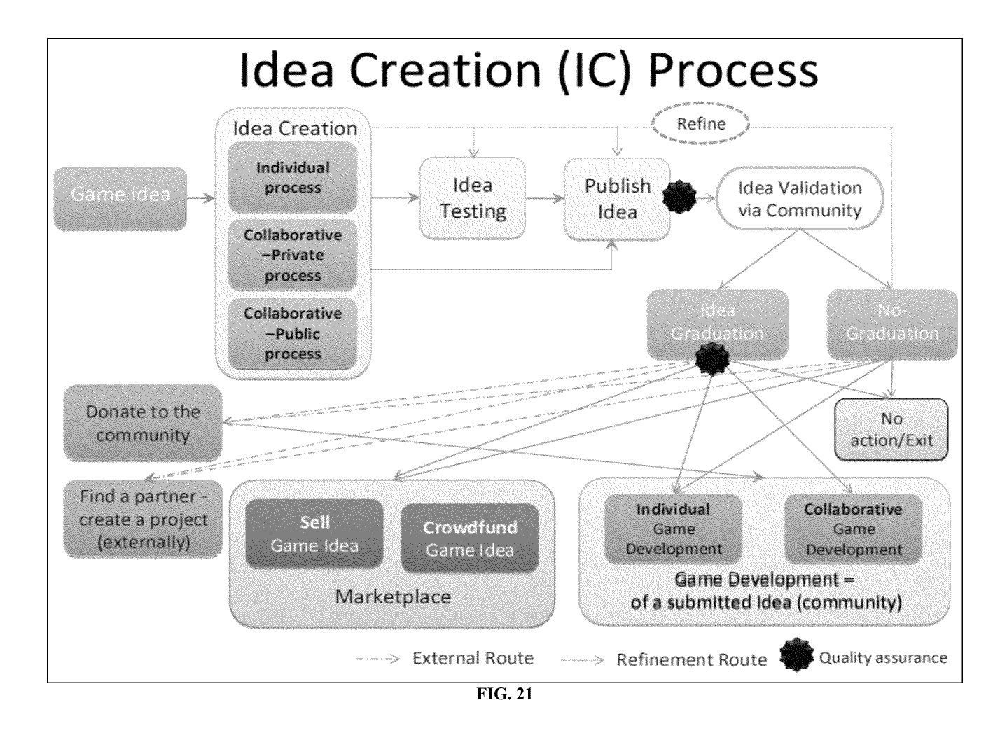

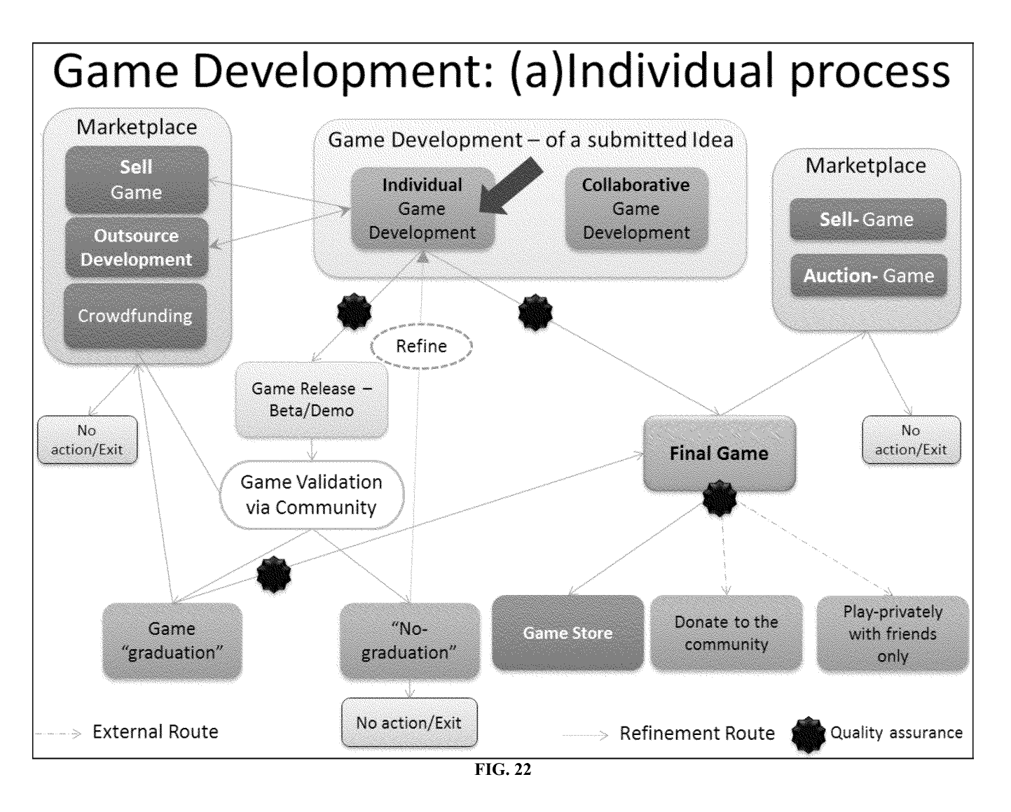

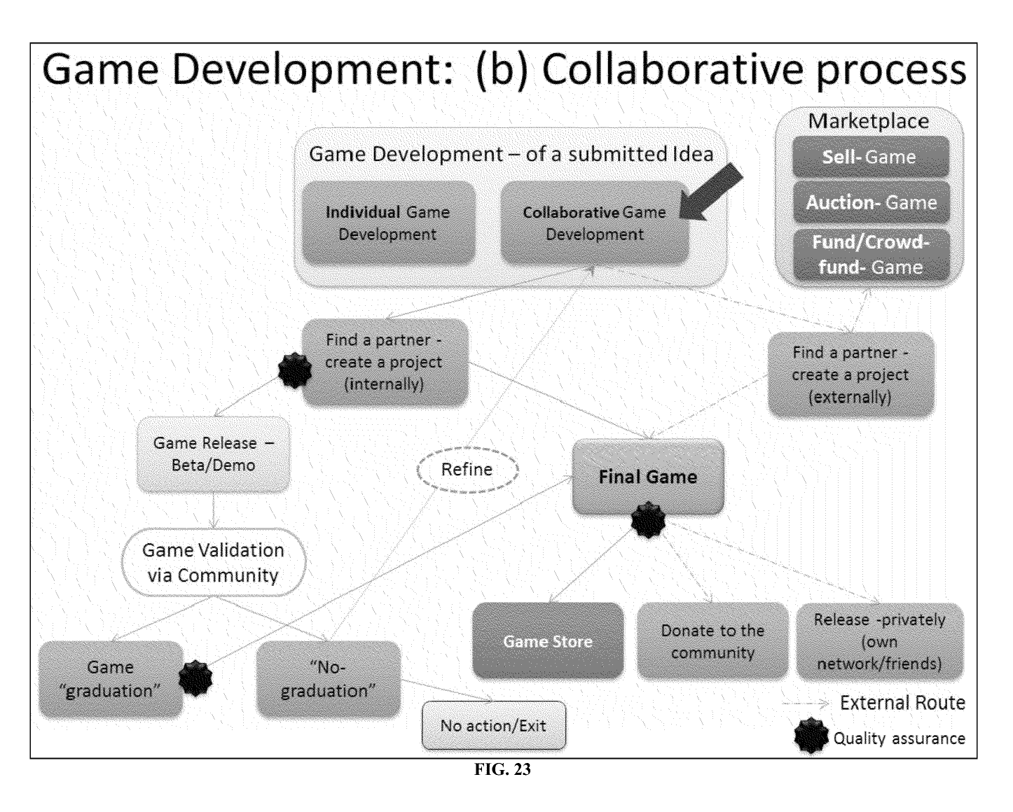

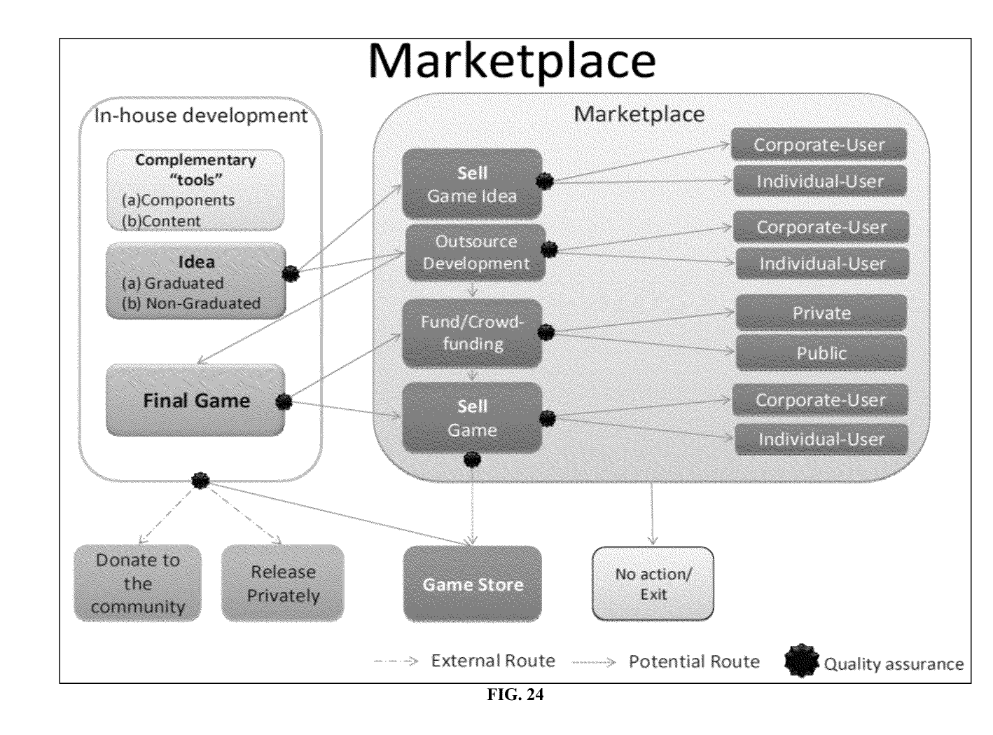

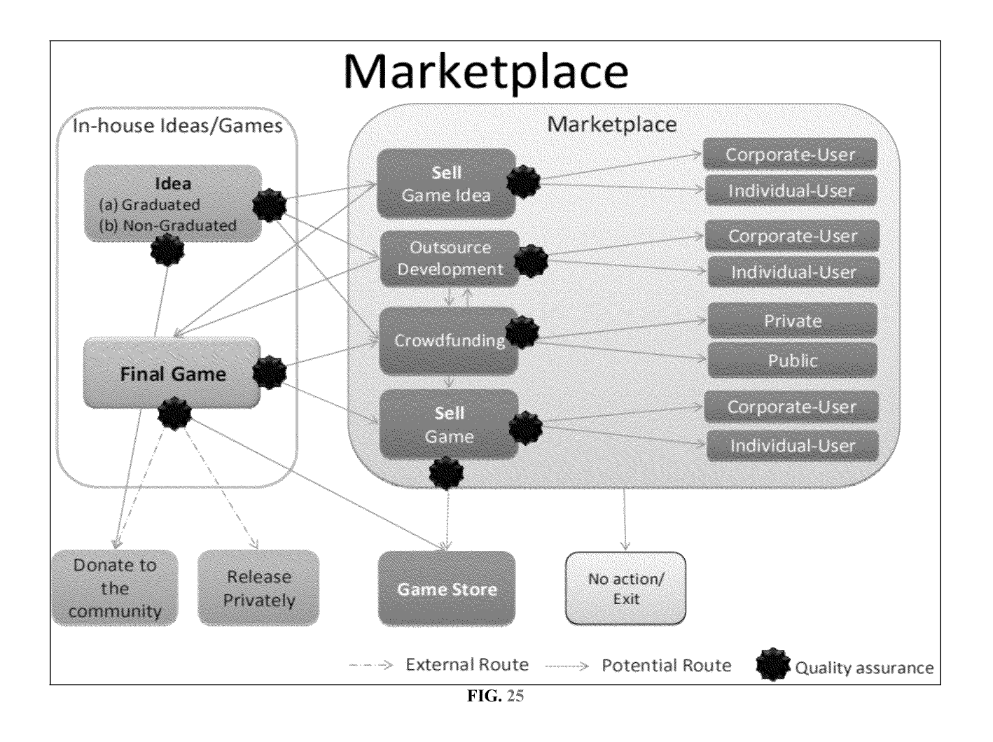

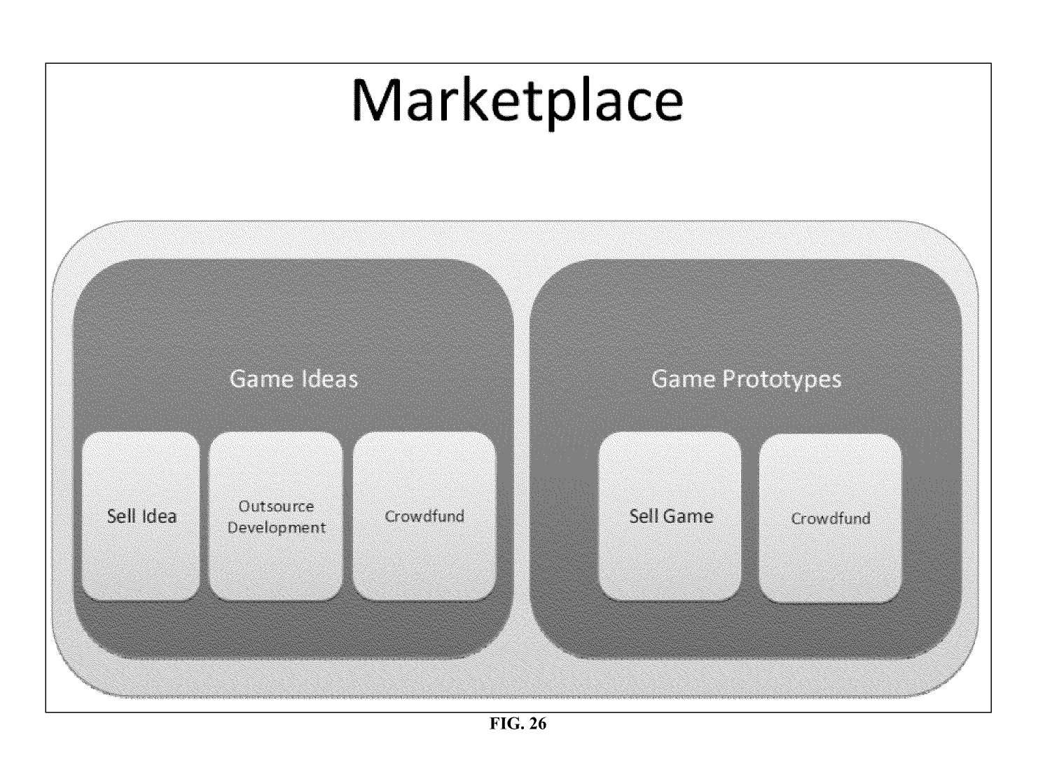

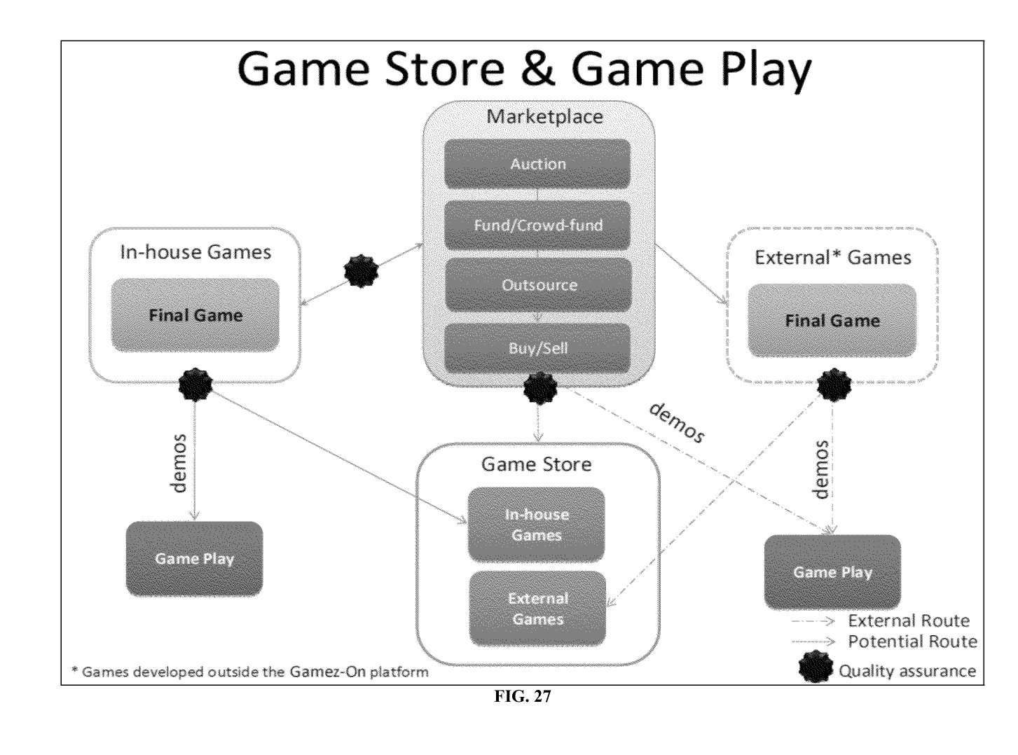

FIGS. 19-27 show exemplary sets of activities that different types users (e.g., unregistered, registered individual user, registered corporate users, etc) can engage in within the inventive virtual gaming platform (identified for convenience in figures as “Gamez-On”) in accordance with some embodiments of the instant invention.

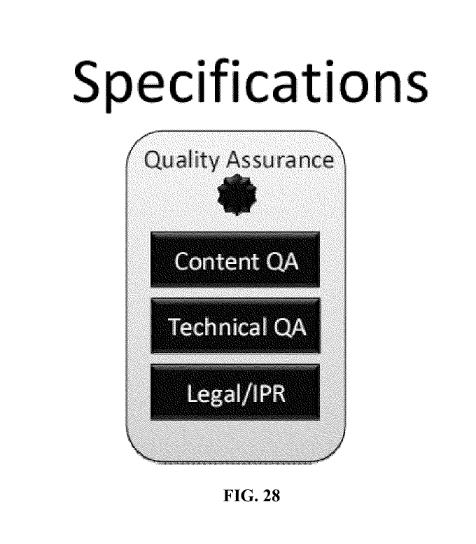

FIG. 28 shows exemplary choices to provide documentation/specification for games during their development and after.

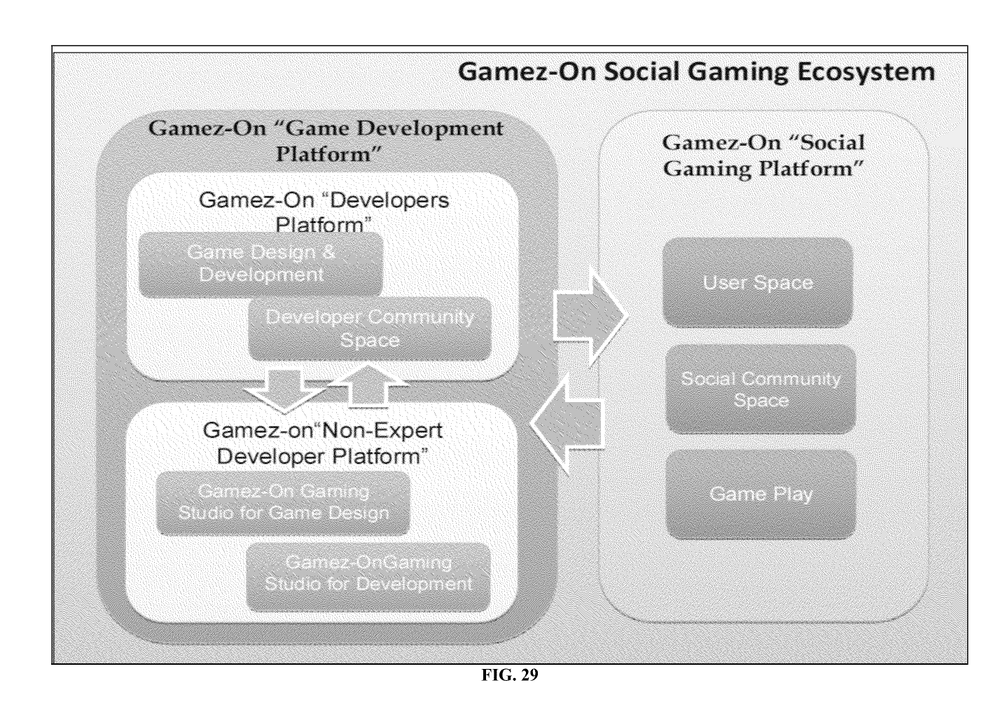

FIG. 29 shows an exemplary interaction map experienced by a user, who is an individual, within the inventive virtual gaming platform in accordance with some embodiments of the instant invention.

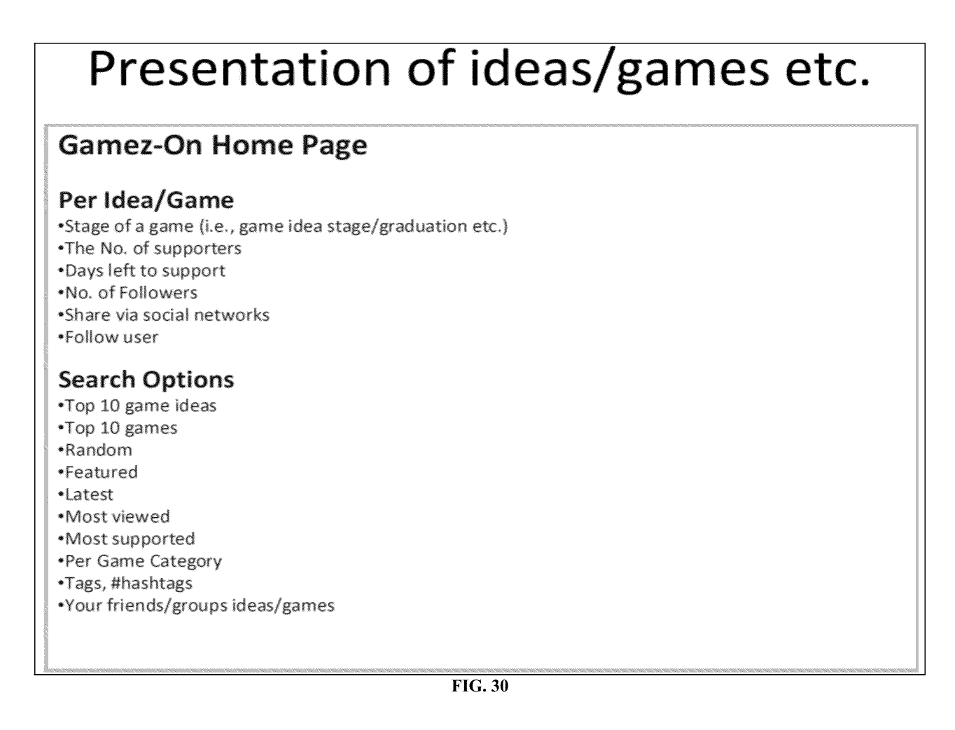

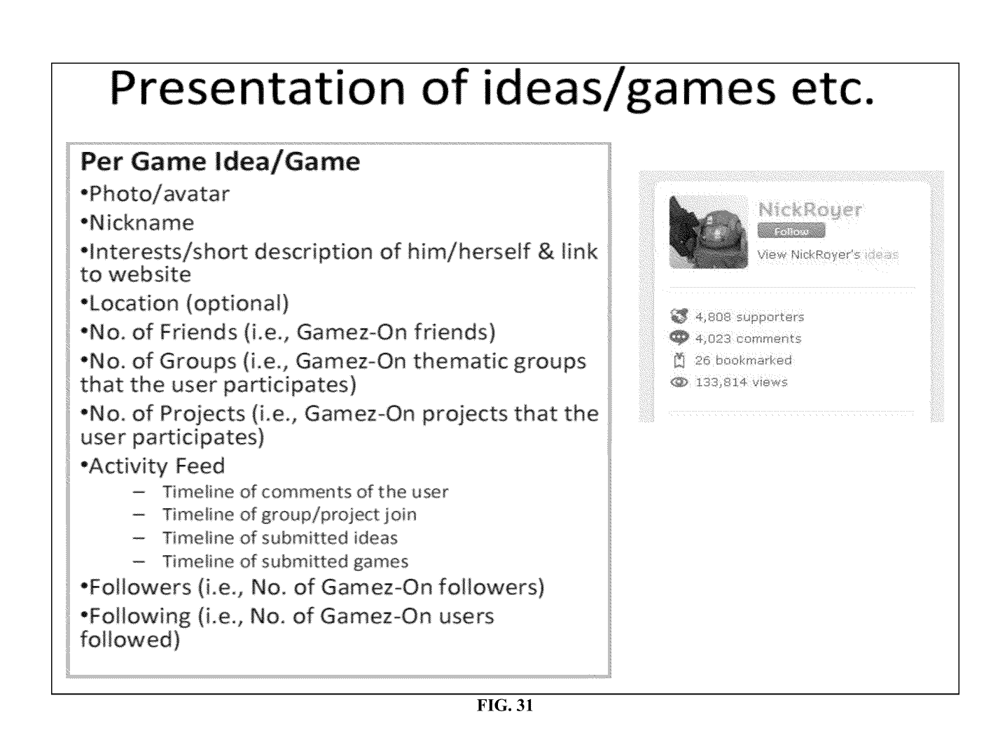

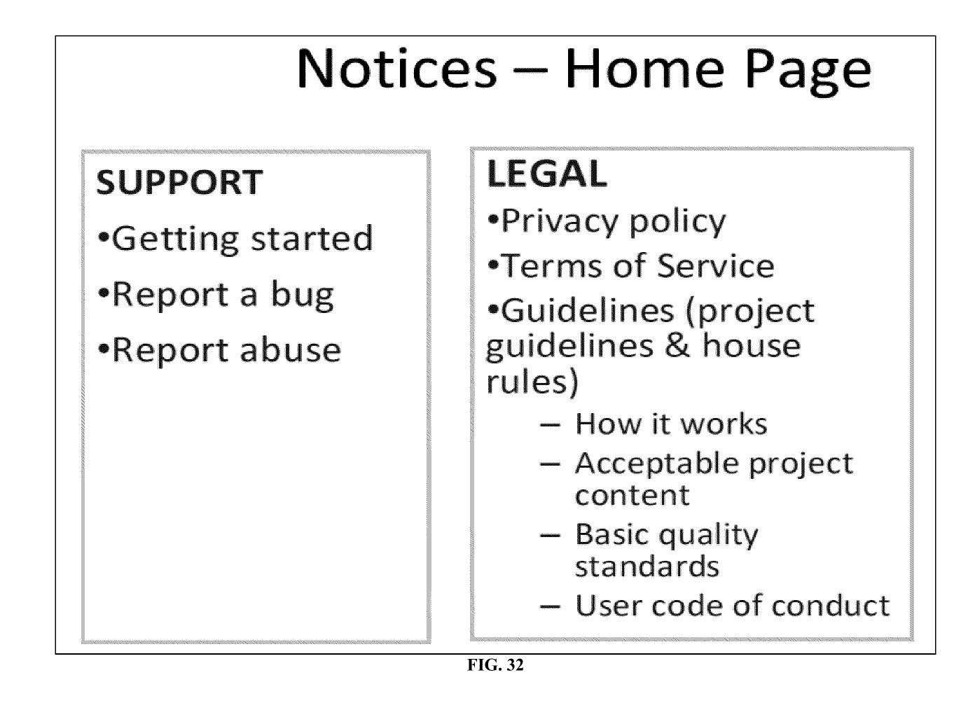

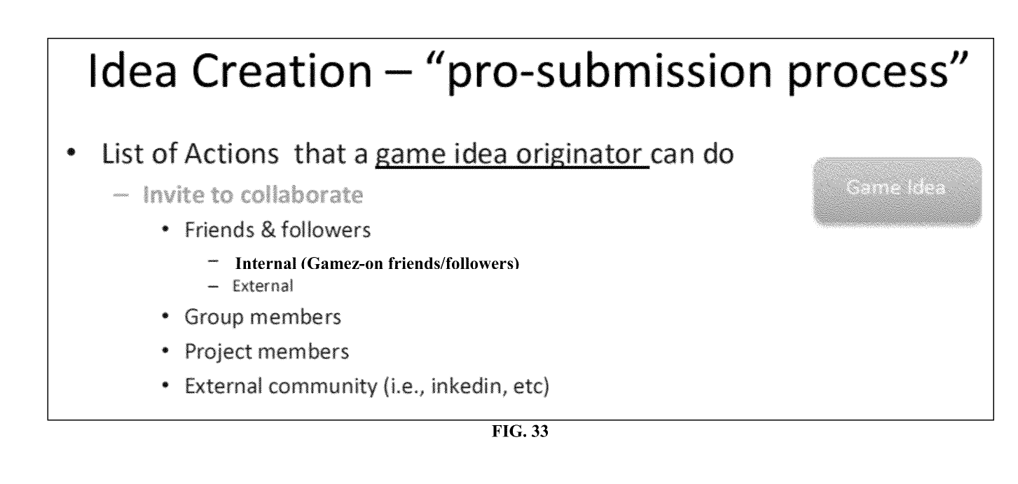

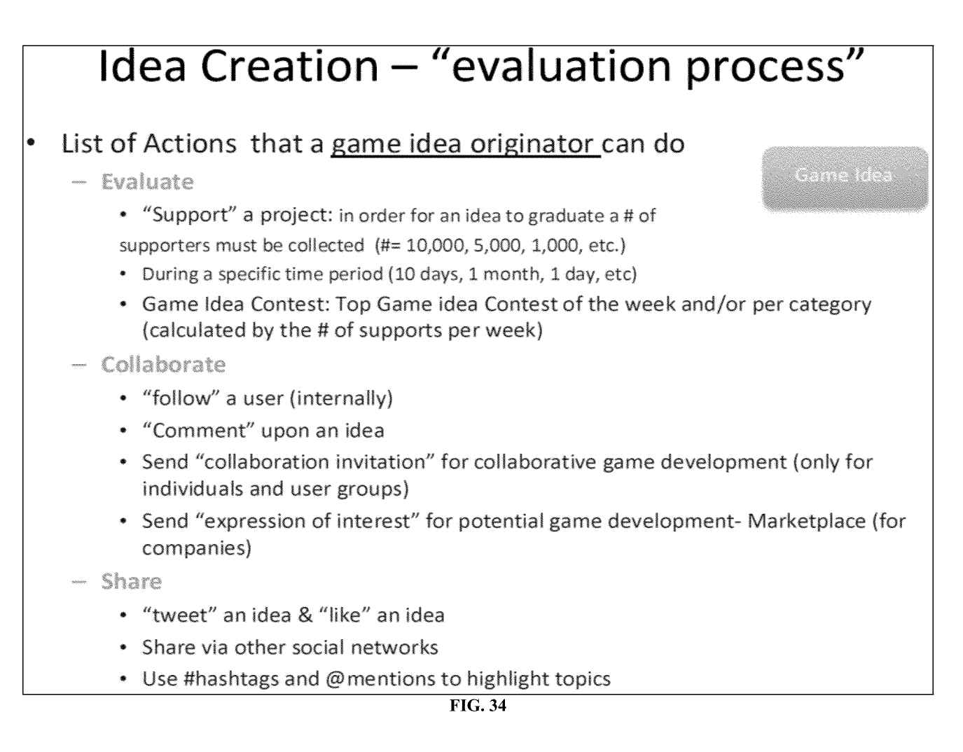

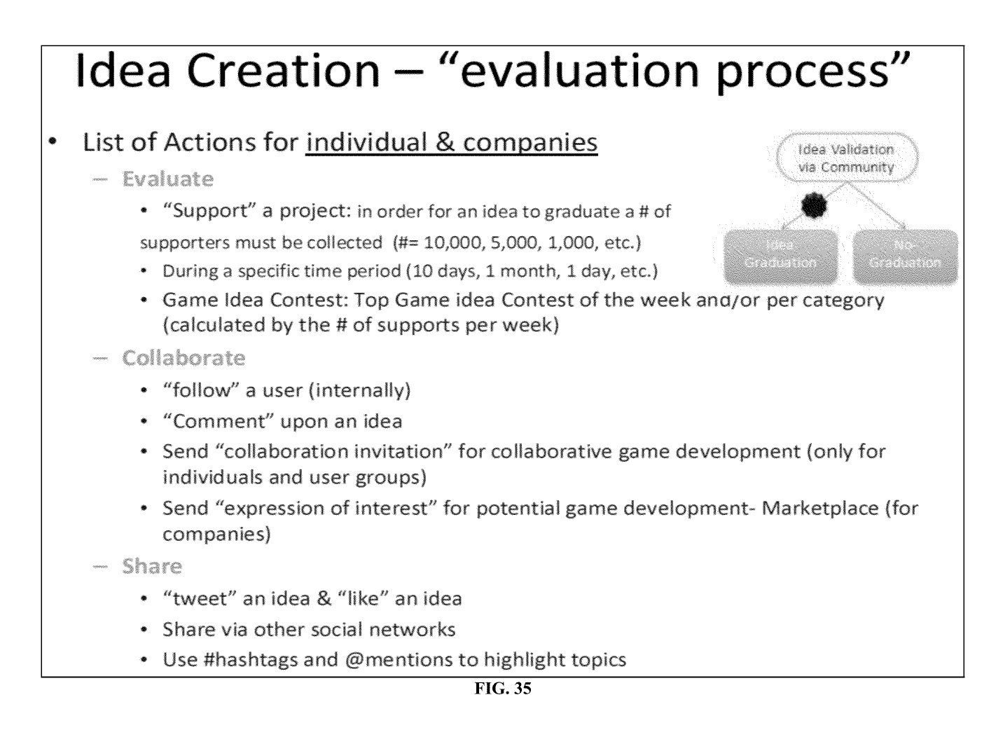

FIG. 30-35 provides exemplary choices/options/information available to users (individuals, companies, etc.) within the inventive virtual gaming platform to generate ideas and develop game(s) in accordance with some embodiments of the instant invention.

In some embodiments, the instant invention provides for a method for community game development and community management of game lifecycle that includes at least the following steps: offering, by a specifically programmed virtual gaming platform, at least one first personalized computer interface to each of at least 1,000 users of an virtual game community managed by the specifically programmed virtual gaming platform; where the at least one first computer interface is configured to allow each of the at least 1,000 users to create at least one game idea; where the specifically programmed virtual gaming platform is configured to concurrently receive the at least one game idea from each of the at least 1,000 users of the virtual game community; where the specifically programmed virtual gaming platform is configured to automatically output, in real-time, a first plurality of game selections during creation of the at least one game idea based, at least in part, on data collected about the virtual game community; receiving, by the specifically programmed virtual gaming platform, a plurality of game ideas; receiving, by the specifically programmed virtual gaming platform, game idea votes on each game idea of the plurality of game ideas; automatically ranking, by the specifically programmed virtual gaming platform, the plurality of game ideas based, at least in part, on the game idea votes; automatically selecting, by the specifically programmed virtual gaming platform, at least one winning game idea to be developed by the virtual game community based, at least in part, on the ranking the plurality of game ideas; automatically identifying, by the specifically programmed virtual gaming platform, at least one first game developer whose at least one skill is suited for development of the at least one winning game idea based, at least in part, on matching at least one characteristic of the at least one winning game idea to information about skills possessed by game developers; automatically determining, by the specifically programmed virtual gaming platform, a role to be performed by at least one first game developer in developing the at least one winning game; receiving, by the specifically programmed virtual gaming platform, funds for developing of the at least one winning game; automatically outputting, in real-time, by the specifically programmed virtual gaming platform, a second plurality of game, where the second plurality of game selections is outputted during the development of the at least one wining game idea based, at least in part, on the data collected about the virtual game community; after the at least one winning game has been developed, tracking, by the specifically programmed virtual gaming platform, a validation of the at least one winning game; after the at least one winning game has been validated, automatically offering, by the specifically programmed virtual gaming platform, the at least one winning game to be played; receiving, by the specifically programmed virtual gaming platform, game reviews to the at least one winning game; managing, by the specifically programmed virtual gaming platform, at least one revision of the at least one winning game based, at least in part, on the game reviews; and offering, by the specifically programmed virtual gaming platform, at least one marketplace where the users of the virtual gaming community can perform at least one of the following activity: i) buy or sell at least one of the following: 1) a first game idea, 2) a first game, 3) a first game component, and 4) a first game content, ii) participate in an auction to buy or sell at least one of the following: 1) a second game idea, 2) a second game, 3) a second game component, and 4) a second game content, iii) fund development of at least one of: 1) the at least one winning game, 2) a third game, 3) a third game idea, 4) a third game component, and 5) a third game content, and iv) outsource development of at least one of: 1) the at least one winning game, 2) a fourth game, 3) a fourth game idea, 4) a fourth game component, and 5) a fourth game content.

In some embodiments, the users are registered members of the virtual game community.

In some embodiments, at least one first user who has created the at least one wining game idea is not the at least one first game developer.

In some embodiments, the at least one game idea comprises at least one game prototype.

In some embodiments, the at least one first personalized computer interface comprises a WYSIWYG-like editor or program.

In some embodiments, the method further includes: registering, by the specifically programmed virtual gaming platform, the game developers with the virtual game community, and offering, by the specifically programmed virtual gaming platform, at least one skills survey during the registering to compile the information about skills possessed by the game developers.

In some embodiments, the method further includes: setting, by the specifically programmed virtual gaming platform, at least one predetermine time period to receive at least one of the following: i) the game idea votes, ii) the validation of the at least one winning game, and iii) the game reviews.

In some embodiments, the method further includes: setting, by the specifically programmed virtual gaming platform, at least one predetermine threshold quantity of at least one of the following: i) the game idea votes, ii) the validation of the at least one winning game, and iii) the game reviews. In some embodiments, the at least one predetermine threshold quantity is at least one of the following: i) at least 1,000, ii) at least 5,000, and iii) at least 10,000.

In some embodiments, the method further includes: offering, by the specifically programmed virtual gaming platform, the users of the virtual game community to access at least one social media network to generate at least one of the following: i) the game idea votes, ii) the validation of the at least one winning game, and iii) the game reviews.

In some embodiments, the instant invention provides for a specifically programmed virtual gaming system that includes at least the following components: at least one specialized computer machine that includes: a non-transient memory having at least one region for storing particular computer executable program code; and at least one processor for executing the particular program code stored in the memory, where the particular program code is configured so that the at least one specialize computer machine is configured to at least perform the following operations: offering at least one first personalized computer interface to each of at least 1,000 users of an virtual game community managed by the specifically programmed virtual gaming platform; where the at least one first computer interface is configured to allow each of the at least 1,000 users to create at least one game idea; where the specifically programmed virtual gaming system is configured to concurrently receive the at least one game idea from each of the at least 1,000 users of the virtual game community; where the specifically programmed virtual gaming system is configured to automatically output, in real-time, a first plurality of game selections during creation of the at least one game idea based, at least in part, on data collected about the virtual game community; receiving a plurality of game ideas; receiving game idea votes on each game idea of the plurality of game ideas; automatically ranking the plurality of game ideas based, at least in part, on the game idea votes; automatically selecting at least one winning game idea to be developed by the virtual game community based, at least in part, on the ranking the plurality of game ideas; automatically identifying at least one first game developer whose at least one skill is suited for development of the at least one winning game idea based, at least in part, on matching at least one characteristic of the at least one winning game idea to information about skills possessed by game developers; automatically determining a role to be performed by at least one first game developer in developing the at least one winning game; receiving funds for developing of the at least one winning game; automatically outputting, in real-time a second plurality of game, where the second plurality of game selections is outputted during the development of the at least one wining game idea based, at least in part, on the data collected about the virtual game community; after the at least one winning game has been developed, tracking a validation of the at least one winning game; after the at least one winning game has been validated, automatically offering the at least one winning game to be played; receiving game reviews to the at least one winning game; managing at least one revision of the at least one winning game based, at least in part, on the game reviews; and offering at least one marketplace where the users of the virtual gaming community can perform at least one of the following activity: i) buy or sell at least one of the following: 1) a first game idea, 2) a first game, 3) a first game component, and 4) a first game content, ii) participate in an auction to buy or sell at least one of the following: 1) a second game idea, 2) a second game, 3) a second game component, and 4) a second game content, iii) fund development of at least one of: 1) the at least one winning game, 2) a third game, 3) a third game idea, 4) a third game component, and 5) a third game content, and iv) outsource development of at least one of: 1) the at least one winning game, 2) a fourth game, 3) a fourth game idea, 4) a fourth game component, and 5) a fourth game content.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A method for community game development and community management of game lifecycle, comprising:
offering, by a specifically programmed virtual gaming platform, at least one first personalized computer interface to each of at least 1,000 users of an virtual game community managed by the specifically programmed virtual gaming platform;
wherein the at least one first computer interface is configured to allow each of the at least 1,000 users to create at least one game idea;
wherein the specifically programmed virtual gaming platform is configured to concurrently receive the at least one game idea from each of the at least 1,000 users of the virtual game community;
wherein the specifically programmed virtual gaming platform is configured to automatically output, in real-time, a first plurality of game selections during creation of the at least one game idea based, at least in part, on data collected about the virtual game community;
receiving, by the specifically programmed virtual gaming platform, a plurality of game ideas;
receiving, by the specifically programmed virtual gaming platform, game idea votes on each game idea of the plurality of game ideas;
automatically ranking, by the specifically programmed virtual gaming platform, the plurality of game ideas based, at least in part, on the game idea votes;
automatically selecting, by the specifically programmed virtual gaming platform, at least one winning game idea to be developed by the virtual game community based, at least in part, on the ranking the plurality of game ideas;
automatically identifying, by the specifically programmed virtual gaming platform, at least one first game developer whose at least one skill is suited for development of the at least one winning game idea based, at least in part, on matching at least one characteristic of the at least one winning game idea to information about skills possessed by game developers;
automatically determining, by the specifically programmed virtual gaming platform, a role to be performed by at least one first game developer in developing the at least one winning game;
receiving, by the specifically programmed virtual gaming platform, funds for developing of the at least one winning game;
automatically outputting, in real-time, by the specifically programmed virtual gaming platform, a second plurality of game, wherein the second plurality of game selections is outputted during the development of the at least one wining game idea based, at least in part, on the data collected about the virtual game community;
after the at least one winning game has been developed, tracking, by the specifically programmed virtual gaming platform, a validation of the at least one winning game;
after the at least one winning game has been validated, automatically offering, by the specifically programmed virtual gaming platform, the at least one winning game to be played;
receiving, by the specifically programmed virtual gaming platform, game reviews to the at least one winning game;
managing, by the specifically programmed virtual gaming platform, at least one revision of the at least one winning game based, at least in part, on the game reviews; and
offering, by the specifically programmed virtual gaming platform, at least one marketplace where the users of the virtual gaming community can perform at least one of the following activity:
i) buy or sell at least one of the following:
1) a first game idea,
2) a first game,
3) a first game component, and
4) a first game content,
ii) participate in an auction to buy or sell at least one of the following:
1) a second game idea,
2) a second game,
3) a second game component, and
4) a second game content,
iii) fund development of at least one of:
1) the at least one winning game,
2) a third game,
3) a third game idea,
4) a third game component, and
5) a third game content, and
iv) outsource development of at least one of:
1) the at least one winning game,
2) a fourth game,
3) a fourth game idea,
4) a fourth game component, and
5) a fourth game content.

2. The method of claim 1, wherein the users are registered members of the virtual game community.

3. The method of claim 1, wherein at least one first user who has created the at least one wining game idea is not the at least one first game developer.

4. The method of claim 1, wherein the at least one game idea comprises at least one game prototype.

5. The method of claim 4, wherein the at least one first personalized computer interface comprises a WYSIWYG-like editor or program.

6. The method of claim 1, wherein the method further comprises:
registering, by the specifically programmed virtual gaming platform, the game developers with the virtual game community, and
offering, by the specifically programmed virtual gaming platform, at least one skills survey during the registering to compile the information about skills possessed by the game developers.

7. The method of claim 1, wherein the method further comprises:
setting, by the specifically programmed virtual gaming platform, at least one predetermine time period to receive at least one of the following:
i) the game idea votes,
ii) the validation of the at least one winning game, and
iii) the game reviews.

8. The method of claim 1, wherein the method further comprises:
setting, by the specifically programmed virtual gaming platform, at least one predetermine threshold quantity of at least one of the following:
i) the game idea votes,
ii) the validation of the at least one winning game, and
iii) the game reviews.

9. The method of claim 8, wherein the at least one predetermine threshold quantity is at least one of the following:
i) at least 1,000,
ii) at least 5,000, and
iii) at least 10,000.

10. The method of claim 1, wherein the method further comprises:
offering, by the specifically programmed virtual gaming platform, the users of the virtual game community to access at least one social media network to generate at least one of the following:
i) the game idea votes,
ii) the validation of the at least one winning game, and
iii) the game reviews.

11. A specifically programmed virtual gaming system for community game development and community management of game lifecycle, comprising:
at least one specialized computer machine, comprising:
a non-transient memory having at least one region for storing particular computer executable program code; and
at least one processor for executing the particular program code stored in the memory, wherein the particular program code is configured so that the at least one specialize computer machine is configured to at least perform the following operations:
offering at least one first personalized computer interface to each of at least 1,000 users of an virtual game community managed by the specifically programmed virtual gaming platform;
wherein the at least one first computer interface is configured to allow each of the at least 1,000 users to create at least one game idea;
wherein the specifically programmed virtual gaming system is configured to concurrently receive the at least one game idea from each of the at least 1,000 users of the virtual game community;
wherein the specifically programmed virtual gaming system is configured to automatically output, in real-time, a first plurality of game selections during creation of the at least one game idea based, at least in part, on data collected about the virtual game community;
receiving a plurality of game ideas;
receiving game idea votes on each game idea of the plurality of game ideas;
automatically ranking the plurality of game ideas based, at least in part, on the game idea votes;
automatically selecting at least one winning game idea to be developed by the virtual game community based, at least in part, on the ranking the plurality of game ideas;
automatically identifying at least one first game developer whose at least one skill is suited for development of the at least one winning game idea based, at least in part, on matching at least one characteristic of the at least one winning game idea to information about skills possessed by game developers;
automatically determining a role to be performed by at least one first game developer in developing the at least one winning game;
receiving funds for developing of the at least one winning game;
automatically outputting, in real-time a second plurality of game, wherein the second plurality of game selections is outputted during the development of the at least one wining game idea based, at least in part, on the data collected about the virtual game community;
after the at least one winning game has been developed, tracking a validation of the at least one winning game;
after the at least one winning game has been validated, automatically offering the at least one winning game to be played;
receiving game reviews to the at least one winning game;
managing at least one revision of the at least one winning game based, at least in part, on the game reviews; and
offering at least one marketplace where the users of the virtual gaming community can perform at least one of the following activity:
i) buy or sell at least one of the following:
1) a first game idea,
2) a first game,
3) a first game component, and
4) a first game content,
ii) participate in an auction to buy or sell at least one of the following:
1) a second game idea,
2) a second game,
3) a second game component, and
4) a second game content,
iii) fund development of at least one of:
1) the at least one winning game,
2) a third game,
3) a third game idea,
4) a third game component, and
5) a third game content, and
iv) outsource development of at least one of:
1) the at least one winning game,
2) a fourth game,
3) a fourth game idea,
4) a fourth game component, and
5) a fourth game content.

12. The system of claim 11, wherein the users are registered members of the virtual game community.

13. The system of claim 11, wherein at least one first user who has created the at least one wining game idea is not the at least one first game developer.

14. The system of claim 11, wherein the at least one game idea comprises at least one game prototype.

15. The system of claim 14, wherein the at least one first personalized computer interface comprises a WYSIWYG-like editor or program.

16. The system of claim 11, wherein the at least one specialized computer machine is further configured to at least perform:
registering the game developers with the virtual game community, and
offering at least one skills survey during the registering to compile the information about skills possessed by the game developers.

17. The system of claim 11, wherein the at least one specialized computer machine is further configured to at least perform:
setting at least one predetermine time period to receive at least one of the following:
i) the game idea votes,
ii) the validation of the at least one winning game, and
iii) the game reviews.

18. The system of claim 11, wherein the at least one specialized computer machine is further configured to at least perform:
setting at least one predetermine threshold quantity of at least one of the following:
i) the game idea votes,
ii) the validation of the at least one winning game, and
iii) the game reviews.

19. The system of claim 18, wherein the at least one predetermine threshold quantity is at least one of the following:
i) at least 1,000,
ii) at least 5,000, and
iii) at least 10,000.

20. The system of claim 11, wherein the at least one specialized computer machine is further configured to at least perform:
offering the users of the virtual game community to access at least one social media network to generate at least one of the following:
i) the game idea votes,
ii) the validation of the at least one winning game, and
iii) the game reviews.
